(19) United States
(12) Patent Application Publication
(10) Pub. No.: US 2026/0346847 A1
(43) Pub. Date: Nov. 5, 2026

(54) TEST NAVIGATION DATASET FOR VERIFICATION AND DEPLOYMENT

(71) Applicant: Pony.ai, Inc., Fremont, CA (US)

(72) Inventors: Zhen Wu, San Jose, CA (US); Andreas Reschka, Foster City, CA (US)

(21) Appl. No.: 19/194,101

(22) Filed: Apr. 30, 2025

(51) Int. Cl. B60W 30/18

(52) U.S. Cl. CPC B60W 30/18163; B60W 2552/53; B60W 2556/05

(57) ABSTRACT

A system includes one or more processors that obtain test navigation data of an ego vehicle, denoise the test navigation data, predict lateral activity scenarios within the test navigation data, characterize the predicted lateral activity scenarios, based on the characterization of the predicted lateral activity scenarios, generate a test navigation dataset, and adjust a steering or actuation command based on the test navigation dataset.

### BACKGROUND

Autonomous vehicles have provided a cornucopia of benefits including improved traffic flow, reduced congestion, energy conservation, reduced accident rate, and navigation efficiency. By 2040, an anticipated 75 percent of vehicles will be autonomous or semi-autonomous, according to the Institute of Electrical and Electronics Engineers (IEEE). However, autonomous vehicles are currently not foolproof. According to current estimates from 2020 or 2021, approximately 9.1 autonomous or semi-autonomous vehicle crashes occur per million miles driven. Reacting to different navigation scenarios, such as those related to lateral activity, is important for autonomous vehicle safety.

### SUMMARY

During verification and validation of autonomous or semi-autonomous (herein “autonomous”) vehicles, a vast volume of test navigation data is generated. However, limitations of interpreting the test navigation data are preventing the test navigation data from being effectively harnessed. In some examples, these limitations are manifested in an inability to identify certain test navigation scenarios, such as lateral activity scenarios within the test navigation data. In some examples, these limitations are manifested in lack of contextualization of the test navigation data.

A claimed solution rooted in computer technology overcomes at least the aforementioned limitations. Embodiments described herein include a test navigation dataset generating system, which may be part of an ego vehicle computing system. The test navigation dataset generating system generates a test navigation dataset that augments test navigation data of an ego vehicle and leverages the test navigation dataset for downstream applications such as those involving vehicle deployment. Test navigation data may include collected data from various sensors, such as perception data and localization data, during test navigation operations of an ego vehicle. Test navigation data may encompass ego vehicle characteristics of the ego vehicle and external characteristics. External characteristics may include environmental characteristics and occupant characteristics of different occupants which include ado occupants. Ado occupants may include pedestrians, animals, and other vehicles. Characteristics may include statuses, attributes, or behaviors.

The test navigation dataset generating system mines or identifies (hereinafter “mines”) test navigation scenarios such as lateral activity scenarios. In some embodiments, at least some of the lateral activity scenarios constitute safety critical scenarios. In some embodiments, lateral activity scenarios correspond to time windows of the test navigation data during which certain characteristics, such as ego vehicle behaviors of the ego vehicle, are exhibited. In some embodiments, lateral activity scenarios include lane changing maneuvers or lane maintaining maneuvers. In some embodiments, lateral activity scenarios may include swerving, lane weaving, and double/multiple lane changing. Lateral activity scenarios may encompass combinations of ego vehicle characteristics, occupant characteristics, and environmental characteristics. The test navigation dataset generating system generates metrics (e.g., lateral activity metrics) that summarize ego vehicle characteristics across the lateral activity scenarios or a subset of lateral activity scenarios. These metrics may include lateral activity type distributions and lateral activity durations. These metrics contextualize the test navigation data by providing baseline ego vehicle characteristics. The test navigation dataset generating system may record and log the metrics as part of the test navigation dataset. The test navigation dataset generating system contextualizes the test navigation data by generating analytics (e.g., lateral activity analytics) which include clustering of the lateral activity scenarios. In some embodiments, clustering may identify degrees of proximity, such as levels of similarities or differences, among the lateral activity scenarios. Clustering may encompass generating embeddings that represent the lateral activity scenarios and generating a cluster map or other proximity representation which depicts the degrees of proximity among the lateral activity scenarios or lateral activity expanded scenarios. Clustering provides relative perspectives of the different lateral activity scenarios via comparisons with other lateral activity scenarios. As a result, the lateral activity scenarios are not viewed in a vacuum.

The test navigation dataset generating system or a different ego vehicle system may leverage the test navigation dataset for downstream applications. These downstream applications include identifying or verifying lateral activity scenarios, detecting anomalies in the ego vehicle or in the environment, generating temporal models that identify changes over time in the ego vehicle or in the environment, adjusting planning algorithms of the ego vehicle, and performing additional testing such as simulation-based testing.

Moreover, clustering also improves downstream decision making of the ego vehicle. For example, as a result of clustering, the ego vehicle system is programmed to identify, during deployment, a previously clustered lateral activity scenario that matches or has a highest level of similarity with a current deployment or deployment scenario. The ego vehicle system may execute actuation or steering commands to conform to, or conform within a threshold range of, the previously logged metrics corresponding to the previously clustered lateral activity scenario. Additionally or alternatively, during deployment, the ego vehicle system may compare deployment metrics, or planned deployment metrics corresponding to a planned trajectory, with previously logged metrics encountered in a same lateral activity scenario or one or more similar lateral activity scenarios. This comparison may serve as a sanity check. In an event of a mismatch between the deployment metrics and the previously logged metrics, the ego vehicle system may selectively adjust certain actuation or steering commands.

The generated navigation dataset provides a more granular and coherent perspective of the navigation data. The generated navigation dataset is also leveraged to diagnose certain navigation conditions. Examples of navigation conditions may include, for example, infrastructure defects such as road defects, or ego vehicle defects such as mechanical or electronic defects. For instance, the generated navigation dataset for the ego vehicle may be compared to ado navigation datasets for other ado vehicles. If the different navigation datasets of the ego vehicle and the ado vehicles all exhibit anomalous behaviors over a same road section, then the anomalous navigation behavior may be more likely attributed to infrastructure defects. However, if an ego vehicle navigation dataset exhibits anomalous behaviors while ado navigation datasets of ado vehicles exhibit normal behaviors, then the anomalous behaviors may be more likely attributed to ego vehicle defects.

Described herein, in some embodiments, is a computing system that generates a test navigation dataset. The system includes one or more processors and a memory storing instructions that, when executed by the one or more processors, cause the computing system to perform operations. The operations include obtaining test navigation data associated with an ego vehicle; denoising the test navigation data; predicting lateral activity scenarios within the test navigation data; characterizing the predicted lateral activity scenarios; based on the characterization of the predicted lateral activity scenarios, generating a test navigation dataset; and executing or adjusting a steering or actuation command based on the test navigation dataset. In some embodiments, the generating of the test navigation dataset, and the previously mentioned operations, occur during a testing, verification, or validation (hereinafter “testing”) phase. In some embodiments, the adjusting a steering or actuation command based on the test navigation dataset occur during a deployment phase.

In some embodiments, the characterizing of the predicted lateral activity scenarios comprises characterizing each of the predicted lateral activity scenarios as a lane changing maneuver or a lane maintaining maneuver.

In some embodiments, the instructions that, when executed by the one or more processors, cause the computing system to perform: diagnosing a navigation condition based on the test navigation dataset and based on ado test navigation datasets, wherein the ado test navigation datasets are associated with ado vehicles; and wherein the adjusting of the steering or actuation command is based on the diagnosis of the navigation condition. For example, if metrics from the test navigation dataset and from the ado test navigation datasets differ over a given route, then the navigation condition may be diagnosed as an ego vehicle defect such as a mechanical or electrical defect. As another example, if metrics from the test navigation dataset and from the ado test navigation datasets are similar over a given route, but differ from other metrics from different routes, or differ from baseline metrics (e.g., metrics that identify normal operation) then the navigation condition may be diagnosed as an infrastructure defect such as a road defect.

In some embodiments, the denoising of the test navigation data comprises constructing sliding windows and generating averaged test navigation data readings within each of the constructed sliding windows.

In some embodiments, the test navigation data comprises lane indicia lateral distance data, which comprises lateral distances between the ego vehicle and one or more adjacent lane indicia at different time instances.

In some embodiments, the predicting of the lateral activity scenarios is based on a pattern of the lane indicia lateral distance data over a predicted lateral activity period, wherein the predicted lateral activity period comprises a time period during which a lateral activity scenario is predicted to occur.

In some embodiments, the predicting or characterizing of the lateral activity scenarios comprises characterizing a left lane change in response to the lane indicia lateral distance data exhibiting a first increasing segment and a second increasing segment, wherein the first increasing segment is discontinuous with respect to the second increasing segment. In some embodiments, the lateral distance between the ego vehicle and the adjacent lane indicia decreases from an end of the first increasing segment to a beginning of the second increasing segment.

In some embodiments, the predicting or characterizing of the lateral activity scenarios comprises characterizing a right lane change in response to the lane indicia lateral distance data exhibiting a first decreasing segment and a second decreasing segment, wherein the first decreasing segment is discontinuous with respect to the second decreasing segment. In some embodiments, the lateral distance between the ego vehicle and the adjacent lane indicia increases from an end of the first decreasing segment to a beginning of the second decreasing segment.

In some embodiments, characterizing the predicted lateral activity scenarios comprises characterizing each of the predicted lateral activity scenarios as a manual lane changing maneuver or an autonomous lane changing maneuver.

In some embodiments, the instructions that, when executed by the one or more processors, cause the computing system to perform: obtaining one or more manual lane changing metrics associated with the characterized manual lane changing maneuvers and one or more autonomous lane changing metrics associated with the characterized autonomous lane changing maneuvers; and wherein the adjusting the steering or actuation command is based on any difference between the manual lane changing metrics and the autonomous lane changing metrics.

Various embodiments of the present disclosure provide a method implemented by a system as described above.

In some embodiments, a computer-implemented method comprises: obtaining test navigation data associated with an ego vehicle; denoising the test navigation data; predicting lateral activity scenarios within the test navigation data; characterizing the predicted lateral activity scenarios; based on the characterization of the predicted lateral activity scenarios, generating a test navigation dataset; and adjusting a steering or actuation command based on the test navigation dataset.

These and other features of the apparatuses, systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an example implementation of a computing system that generates a test navigation dataset.

FIG. 2 illustrates an example of test navigation data.

FIG. 3A is a block diagram that depicts an example implementation of the computing system of FIG. 1 in more detail.

FIG. 3B is a diagram that illustrates an example vehicle system context related to generating a test navigation dataset, as well as other functions associated with an ego vehicle computing system.

FIGS. 4A and 4B illustrate example implementations of denoising of test navigation data.

FIGS. 5, 6, 7, and 8 illustrate lateral activity scenario templates used to predict or characterize lateral activities.

FIG. 5 illustrates a left lane change template.

FIG. 6 illustrates a right lane change template.

FIG. 7 illustrates a lane maintaining template.

FIG. 8 illustrates a swerving template.

FIG. 9 illustrates an example lateral activity characterization database that stores one or more test navigation datasets.

FIG. 10 illustrates an example lateral activity dataset.

FIGS. 11 and 12 illustrate examples of lateral activity metrics, which include a lateral activity overall time distribution data and a lateral activity instance duration data.

FIG. 13A illustrates example lateral activity expanded scenario relational data which depicts relationships among lateral activity expanded scenarios.

FIG. 13B illustrates example lateral activity expanded scenario characterization data, which describes each lateral activity expanded scenario that is illustrated in FIG. 13A.

FIG. 14 illustrates a lateral activity dataset interface.

FIGS. 15-16 are flowcharts which summarize exemplary processes of adjusting or executing autonomous programming or restricting certain manual actions based on the generated test navigation datasets.

FIG. 17 illustrates example implementations of downstream actions following the generating of a test navigation dataset.

FIGS. 18 and 19 illustrate example ego vehicles in which the aforementioned implementations may be implemented.

FIG. 20 is a block diagram of a computer system upon which any of the embodiments described herein may be implemented.

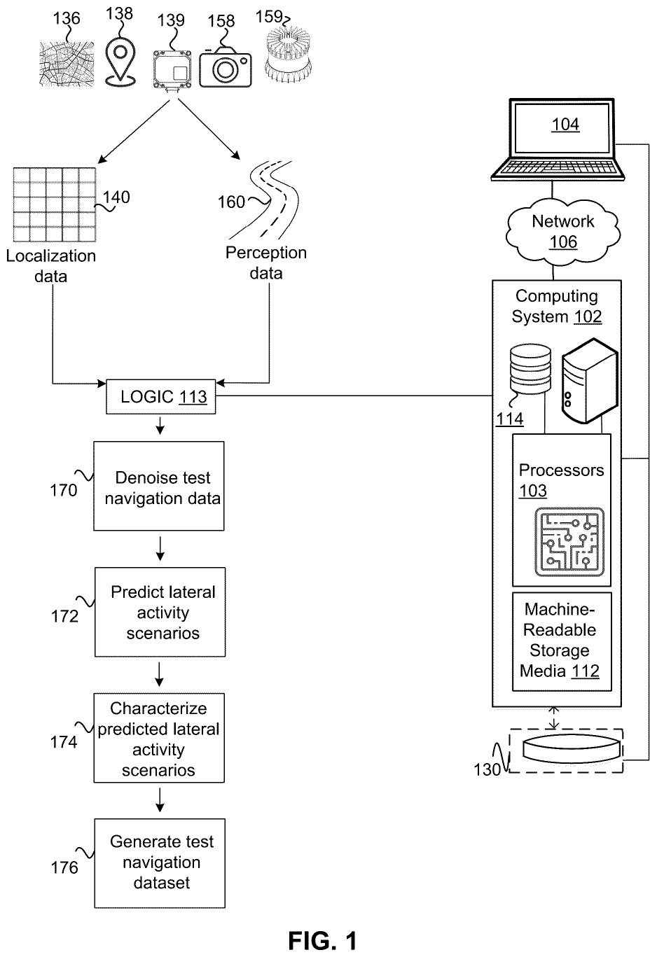

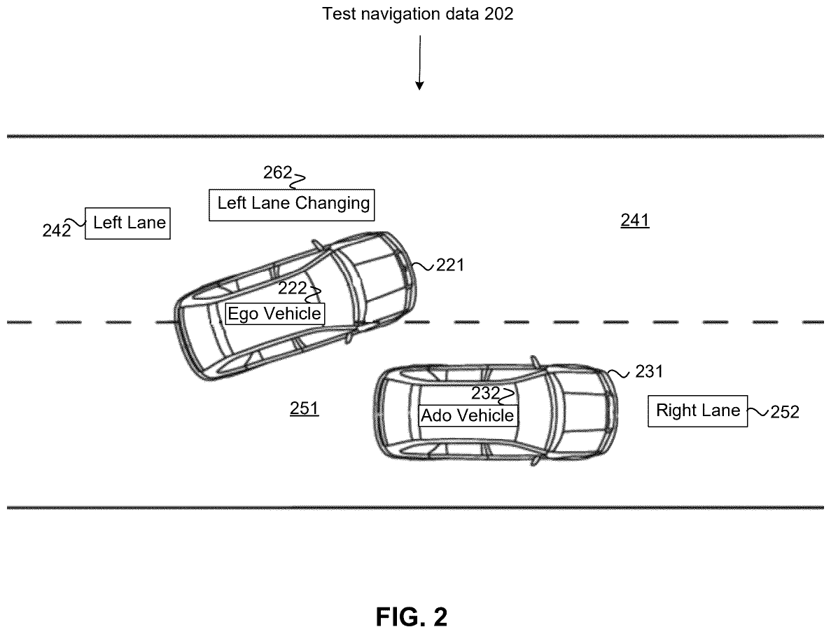

Principles from any of the different figures may apply to, and/or be combined with other figures as suitable. For example, the principles illustrated in FIGS. 1 and 2 may be applied to or combined with principles from any of FIGS. 2, 3A, 3B, 4A, 4B, 5-12, 13A, 13B, 14-16, and vice versa.

### DETAILED DESCRIPTION

During verification and validation of autonomous or semi-autonomous (herein “autonomous”) vehicles, a vast volume of test navigation data is generated. However, limitations of interpreting the test navigation data are preventing the test navigation data from being effectively harnessed. In some examples, these limitations are manifested in an inability to identify certain test navigation scenarios, such as lateral activity scenarios within the test navigation data. In some examples, these limitations are manifested in lack of contextualization of the test navigation data.

A claimed solution rooted in computer technology overcomes at least the aforementioned limitations. Embodiments described herein include a test navigation dataset generating system, which generates a test navigation dataset that augments test navigation data of an ego vehicle and leverages the test navigation dataset for downstream applications such as those involving vehicle deployment. Test navigation data may include collected data from various sensors, such as perception data and localization data, during test navigation operations of an ego vehicle. Test navigation data may encompass ego vehicle characteristics of the ego vehicle and external characteristics. External characteristics may include environmental characteristics and occupant characteristics of different occupants which include ado occupants. Ado occupants may include pedestrians, animals, and other vehicles. Characteristics may include statuses, attributes, or behaviors.

The test navigation dataset generating system mines or identifies (hereinafter “mines”) test navigation scenarios such as lateral activity scenarios. In some embodiments, at least some of the lateral activity scenarios constitute safety critical scenarios. In some embodiments, lateral activity scenarios correspond to time windows of the test navigation data during which certain characteristics, such as ego vehicle behaviors of the ego vehicle, are exhibited. In some embodiments, lateral activity scenarios include lane changing maneuvers or lane maintaining maneuvers. In some embodiments, lateral activity scenarios may include swerving, lane weaving, and double/multiple lane changing. Lateral activity scenarios may encompass combinations of ego vehicle characteristics, occupant characteristics, and environmental characteristics. The test navigation dataset generating system generates metrics that summarize ego vehicle characteristics across the lateral activity scenarios or a subset of lateral activity scenarios. These metrics may include lateral activity type distributions and lateral activity durations. These metrics contextualize the test navigation data by providing baseline ego vehicle characteristics. The test navigation dataset generating system may record and log the metrics as part of the test navigation dataset. The test navigation dataset generating system contextualizes the test navigation data by generating analytics which include clustering of the lateral activity scenarios. In some embodiments, clustering may identify degrees of proximity, such as levels of similarities or differences, among the lateral activity scenarios. Clustering may encompass generating embeddings that represent the lateral activity scenarios and generating a cluster map or other proximity representation which depicts the degrees of proximity among the lateral activity scenarios or lateral activity expanded scenarios. Clustering provides relative perspectives of the different lateral activity scenarios via comparisons with other lateral activity scenarios. As a result, the lateral activity scenarios are not viewed in a vacuum.

The test navigation dataset generating system or a different ego vehicle system may leverage the test navigation dataset for downstream applications. These downstream applications include identifying or verifying lateral activity scenarios, detecting anomalies in the ego vehicle or in the environment, generating temporal models that identify changes over time in the ego vehicle or in the environment, adjusting planning algorithms of the ego vehicle, and performing additional testing such as simulation-based testing.

Moreover, clustering also improves downstream decision making of the ego vehicle. For example, as a result of clustering, the ego vehicle system is programmed to identify, during deployment, a previously clustered lateral activity scenario that matches or has a highest level of similarity with a current deployment or deployment scenario. The ego vehicle system may execute actuation or steering commands to conform to, or conform within a threshold range of, the previously logged metrics corresponding to the previously clustered lateral activity scenario. Additionally or alternatively, during deployment, the ego vehicle system may compare deployment metrics, or planned deployment metrics corresponding to a planned trajectory, with previously logged metrics encountered in a same lateral activity scenario or one or more similar lateral activity scenarios. This comparison may serve as a sanity check. In an event of a mismatch between the deployment metrics and the previously logged metrics, the ego vehicle system may selectively adjust certain actuation or steering commands.

The generated navigation dataset provides a more granular and coherent perspective of the navigation data. The generated navigation dataset is also leveraged to diagnose certain navigation conditions. Examples of navigation conditions may include, for example, infrastructure defects such as road defects, or ego vehicle defects such as mechanical or electronic defects. For instance, the generated navigation dataset for the ego vehicle may be compared to ado navigation datasets for other ado vehicles. If the different navigation datasets of the ego vehicle and the ado vehicles all exhibit anomalous behaviors over a same road section, then the anomalous navigation behavior may be more likely attributed to infrastructure defects. However, if an ego vehicle navigation dataset exhibits anomalous behaviors while ado navigation datasets of ado vehicles exhibit normal behaviors, then the anomalous behaviors may be more likely attributed to ego vehicle defects.

The subsequent figures further elucidate some of the aforementioned details and illustrate how generating of a test navigation dataset improves not only verification and validation of an ego vehicle, but also deployment. The computing improvements are evident in increased safety as a result of more efficient recognition and execution of lateral activity scenarios and an increased awareness, of the ego vehicle system, of a more diverse range of lateral activity scenarios.

FIG. 1 illustrates an example implementation of a computing system 102 that generates a test navigation dataset. The test navigation dataset may be leveraged to program an ego vehicle or adjust restrictions or limitations of manual operation of the ego vehicle. In some embodiments, the computing system 102 may be, or may be incorporated as part of, an ego vehicle system which may also execute or adjust steering or actuation commands to effectuate steering or actuation maneuvers in the ego vehicle. In some embodiments, the computing system 102 may include a test navigation dataset generating system. The ego vehicle may include a vehicle (e.g., an autonomous vehicle) that is making locomotive decisions and executing the locomotive decisions while responding to different stimuli.

The computing system 102 obtains sensor data from a multitude of sensors of different modalities, including map data 136, Global Positioning System (GPS) data 138, inertial measurement units (IMUs) 139, cameras 158, Lidars 159, radars, sonars, ultrasonic sensors, accelerometers, gyroscopes, magnetometers, and FIR (far infrared) sensors. In some embodiments, the sensor data may include test navigation data which may be categorized as localization data 140 or perception data 160. In some embodiments, test navigation data may be collected during verification and validation of the ego vehicle. Test navigation data may include lane indicia lateral distance data which includes computed distances of the ego vehicle to adjacent lane indicia at various timestamps. Lane indicia may indicate or may have at least a threshold probability of containing lane markings or boundaries on a road, or portions thereof.

The sensors may capture media data and/or data of different formats. The sensor data may include, or be augmented with, textual and/or structured data. The textual data may include textual descriptions of environmental characteristics, and ego vehicle characteristics such as logs of any disengagements or other anomalies which may be associated with post-encroachment or near misses, other incident reports. The structured data may include tabular data or formatted data organized in a particular format. In some embodiments, the computing system 102 may integrate or fuse the sensor data to transform the disparate data sources into a comprehensive, unified data collection. To integrate the sensor data of different formats, the computing system 102 may normalize the different formats into a standardized format, such as fusing camera and Lidar data. In some embodiments, the integrating of the sensor data may include other data transformations such as data frame construction and/or compressing data.

The computing system 102, in step 170, denoises the test navigation data, such as the lane indicia lateral distance data. In some embodiments, denoising the test navigation data may include filtering out, eliminating or reducing noise, outliers, or other anomalies within the test navigation data. Denoising may include constructing sliding windows within the lane indicia lateral distance data, smoothing using a sliding window filter, and generating statistics within each of the sliding windows or across adjacent sliding windows. In some embodiments, the statistics may include averages or standard deviations of the distances, gradients, and deltas which may include changes in average distance across two adjacent sliding windows. In some embodiments, sliding windows may refer to time windows.

Next, the computing system 102, in step 172, performs predicting of lateral activity scenarios. In some embodiments, predicting lateral activity scenarios includes identifying potential lane indicia crossings based on deltas of the generated statistics across adjacent sliding windows. For example, if the deltas across one or more adjacent sliding windows exceed a distance threshold, then the computing system 102 may predict an occurrence of one or more lateral activity scenarios such as a lane change. In some embodiments, predicting lateral activity scenarios may be based on one or more standard deviations, for example, across one or more lane maintaining scenarios. For example, the distance threshold may be defined relative to the one or more standard deviations. When a delta across different adjacent sliding windows exceeds the distance threshold, then the computing system 102 may predict or characterize a lane change.

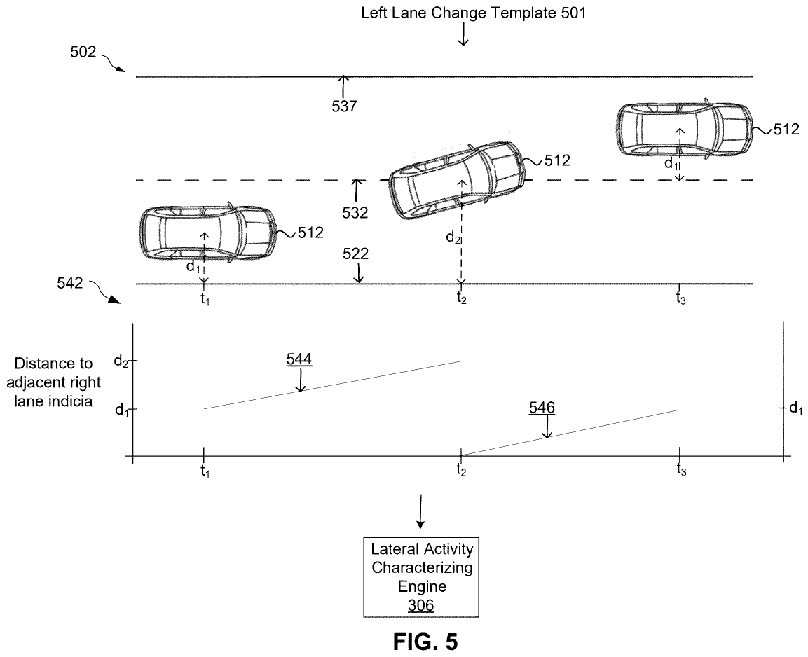

In step 174, the computing system 102 may characterize the predicted lateral activity scenarios. In some embodiments, characterizing may include comparing the lane indicia lateral distance data to one or more patterns or templates, as illustrated in FIGS. 5-8, to determine whether the lane indicia lateral distance data sufficiently conforms to one or more templates. In some embodiments, characterizing the predicted lateral activity scenarios may include determining a direction or a type of a lane change. In some embodiments, characterizing the predicted lateral activity scenarios may include interval adjustment which may include extending or shrinking the predicted lateral activity periods or predicted lateral period intervals (hereinafter “lateral activity periods”) so that each lateral activity period captures an entire duration of a lateral activity scenario. In some embodiments, characterizing the predicted lateral activity scenarios may include detecting a mode of the lateral activity such as whether the lateral activity scenario occurred in manual or autonomous mode. Autonomous may mean that no manual (e.g., safety driver) intervention occurred, while manual may mean that manual intervention occurred.

In step 176, the computing system 102 may generate a test navigation dataset based on the characterized lateral activity scenarios. In some embodiments, generating the test navigation dataset may include augmenting the characterized lateral activity scenarios with metrics and analytics that provide contextualization of the test navigation data. The test navigation dataset may be leveraged to improve subsequent ego vehicle verification and validation, and improve safety of deployment.

In FIG. 1, an implementation that includes the computing system 102 can include at least one computing device 104 which may be operated by an entity such as a user. The computing device 104 may be located in an interior of the ego vehicle or outside of the ego vehicle. The user may submit a request or query through the computing device 104. The computing device 104 may receive the request or query from the user or from another computing device, computing process, artificial intelligence (AI) process, service, or pipeline. Such a request or query may relate or pertain to operations to retrieve, search for, or mine (hereinafter “retrieve”) one or more lateral activity scenarios. A portion or all of the results including the lateral activity scenarios and associated metadata, such as lateral activity scenario data (e.g., raw lateral activity scenario data or processed lateral activity scenario data), may be stored in a database 130. In general, the user can interact with the database 130 directly or over a network 106, for example, through one or more graphical user interfaces, application programming interfaces (APIs), and/or webhooks. The computing device 104 may include one or more processors and memory. In some examples, the computing device 104 may visually render any outputs generated, such as the lateral activity scenarios.

The computing system 102 may include one or more processors 103 which may be configured to perform various operations by interpreting machine-readable instructions, for example, from a machine-readable storage media 112. In some examples, one or more of the processors 103 may be combined or integrated into a single processor, and some or all functions performed by one or more of the processors 103 may not be spatially separated, but instead may be performed by a common processor. The processors 103 may be physical or virtual entities. For example, as physical entities, the processors 103 may include one or more processing circuits, each of which can include one or more processing cores. Additionally or alternatively, for example, as virtual entities, the processors 103 may be encompassed within, or manifested as, a program within a cloud environment. The computing system 102 may also include or be associated with a storage 114, which may include a cache for faster access compared to the database 130.

The processors 103 may further be connected to, include, or be embedded with logic 113 which, for example, may include, store, and/or encapsulate instructions that are executed to carry out the functions of the processors 103. In general, the logic 113 may be implemented, in whole or in part, as software that is capable of running on the computing system 102, and may be read or executed from the machine-readable storage media 112. The logic 113 may include, as nonlimiting examples, parameters, expressions, functions, arguments, evaluations, conditions, and/or code. Here, in some examples, the logic 113 encompasses functions of or related to generating a test navigation dataset and storing the test navigation dataset within the database 130. Functions or operations described with respect to the logic 113 may be associated with a single processor or multiple processors.

The database 130 may store, or be capable of obtaining and storing, the test navigation data, the denoised test navigation data, the predicted lateral activity scenarios, the characterized lateral activity scenarios, and the test navigation dataset. The database 130 may store any intermediate and/or final outputs during the generating of the test navigation dataset. The database 130 may store each lateral activity scenario such that a relevant subset of the test navigation data and the denoised test navigation data corresponding to a particular lateral activity scenario is mapped together or linked (hereinafter “mapped”). In some examples, the test navigation data may encompass raw navigation data or annotated navigation data that includes annotations, tags, and/or labels (hereinafter “annotations”). The annotations may describe one or more characteristics such as ego vehicle characteristics and environment characteristics. These characteristics may include entities, events, activities, and/or inferences.

In some embodiments, the annotations may conform to an ontological framework. This ontological framework may include a criteria or guideline of links or associations, or inferred links, between locomotive concepts and annotations or combinations of annotations. For instance, the ontological framework may link a lateral activity scenario that has annotations including a vehicle and an opposite direction vehicle (e.g., a vehicle driving in an opposite direction) driving in a same lane as the vehicle to a concept of wrong direction driving and/or an attempted lane change. In particular, the ontological framework may link any combination of annotations indicative of dynamic entities including a vehicle and/or a pedestrian, vehicle and/or pedestrian signaling, and static entities such as a building, a road, and/or a traffic sign, to particular locomotive concepts.

In some examples, the ontological framework may associate lateral activity scenarios with one or more specific locomotive concepts. For example, the ontological framework may associate characterization of a specific locomotive concept with feasible, plausible, or likely subsequent or current scenarios. In a particular example, the ontological framework may associate a characterization of a locomotive concept, such as “wrong direction driving,” with a predicted future scenario of an ego vehicle changing lanes to pull over in order to yield to the vehicle that is travelling in a wrong direction. In some examples, the ontological framework may, from a characterization of a locomotive concept, associate one or more preceding scenarios by predicting one or more previous scenarios that were likely to have occurred previously. For example, the ontological framework may associate a locomotive concept of yielding to a pedestrian at a crosswalk, during a lane maintaining maneuver or lane maintaining scenario, with a previous scenario in which the pedestrian entered the crosswalk prior to a vehicle entering an intersection. Additionally, the ontological framework may associate a given locomotive concept with related (e.g., concepts that are related and have different levels of granularity, such as more general or more specific concepts) and/or alternative permutations of that locomotive concept. For example, concepts that are related and have different levels of granularity, such as more general or more specific concepts, may be linked together. As a specific example, if the locomotive concept is or includes cutting in, then the ontological framework may associate that locomotive concept with a lane change maneuver or a lane change scenario.

In some examples, the ontological framework may associate or map any combination of annotations to a danger level, such as a probability of disengagement, in order to identify certain combinations of annotations that correspond to a high probability of disengagements (e.g., above a threshold probability, such as 25 percent, 50 percent, 75 percent or any applicable percentage).

FIG. 2 illustrates an example of test navigation data 202. In FIG. 2, the test navigation data 202 may include lateral activity scenario data capturing a test navigation environment of an ego vehicle 221, which may include ego vehicle characteristics and external characteristics. The ego vehicle characteristics may include ego vehicle behaviors such as locomotion of the ego vehicle 221. The test navigation data 202 may include frames of media data, textual data, and other data. The test navigation data 202 may or may not include annotations. In the example shown in FIG. 2, the test navigation data 202 may include the ego vehicle 221, and an ado vehicle 231. The ego vehicle 221 may initially be in a right lane 251 and changing to a left lane 241. The ado vehicle 231 may be in the right lane 251. The test navigation data 202 may include one or more annotations such as an ego vehicle annotation 222, an ado vehicle annotation 232, a right lane annotation 252, a left lane annotation 222, and a left lane changing annotation 262 which signifies the ego vehicle 221 is changing to the left lane 241.

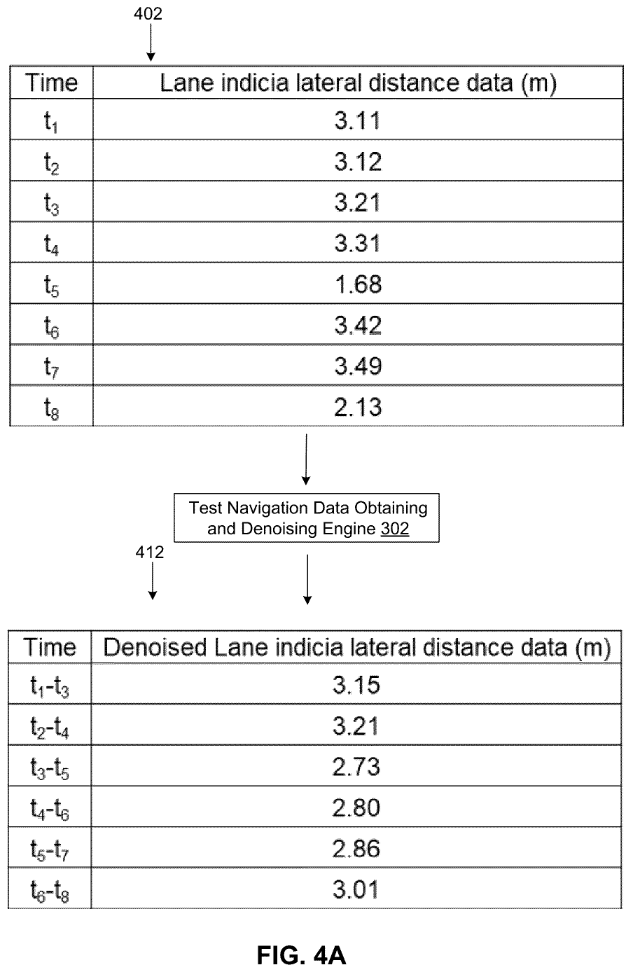

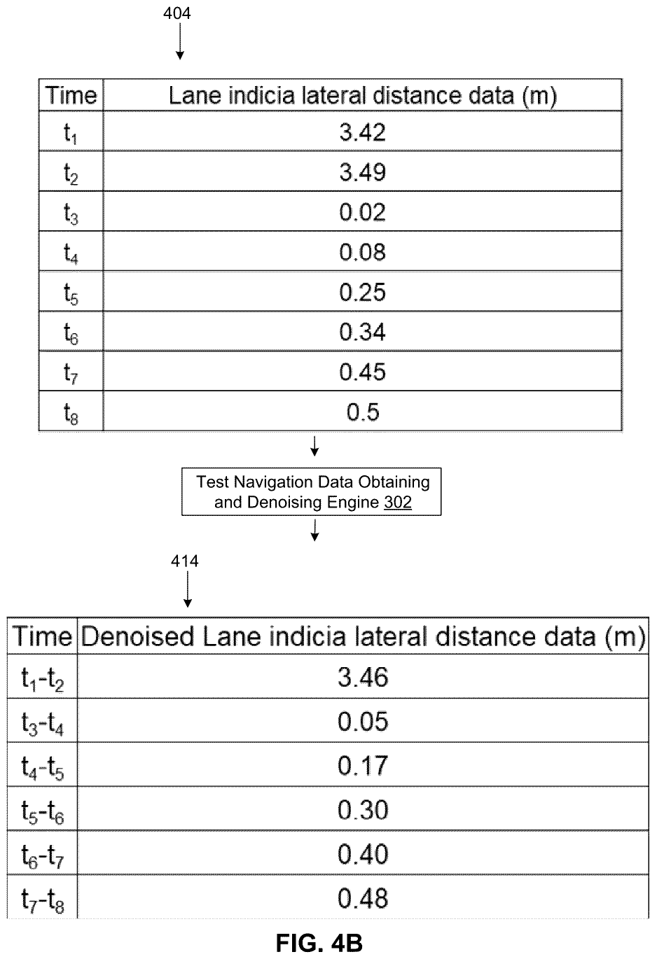

FIG. 2 is merely exemplary. In some embodiments, the test navigation data 202 may additionally or alternatively include time series data such as lane indicia lateral distance data, as illustrated in FIGS. 4A and 4B. In some embodiments, the lane indicia lateral distance data may be derived from the captured test navigation environment. Although the description focuses on lateral activity scenario data, the test navigation data 202 is not construed to be limited to lateral activity scenario data.

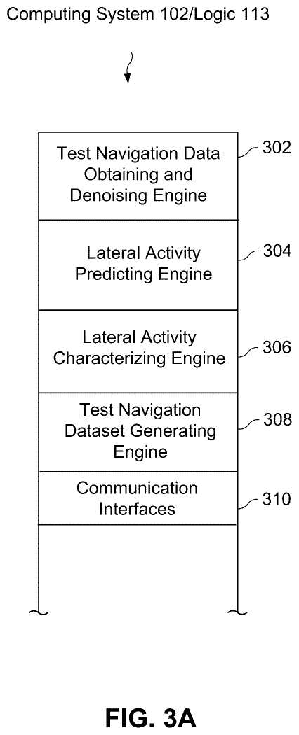

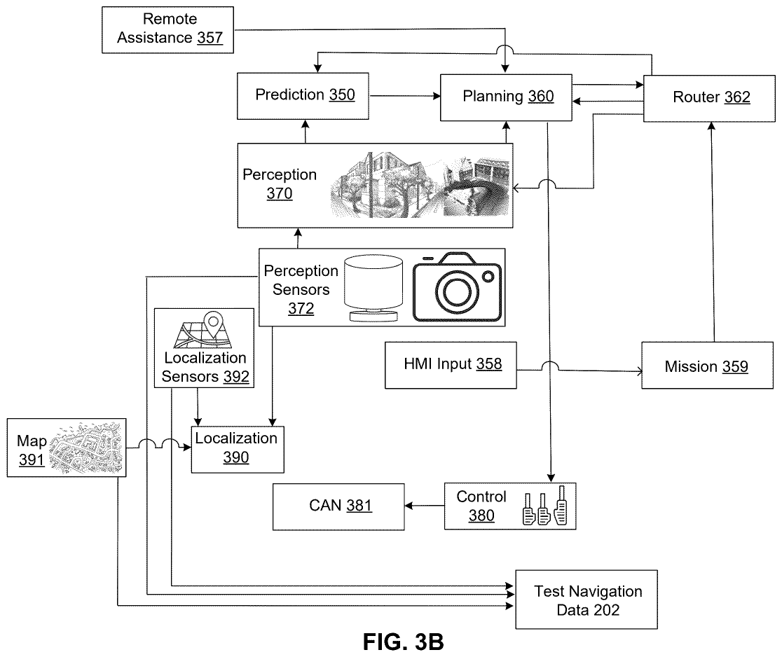

FIG. 3A is a block diagram that depicts an example implementation of the computing system 102 and/or the logic 113, in accordance with some embodiments. The computing system 102 contains hardware, software and/or firmware capable of communicating with any of the aforementioned sensors (e.g., the GPS 138, the IMU 139, the camera 158, the Lidar 159, radars, sonars, ultrasonic sensors, accelerometers, gyroscopes, magnetometers, and FIRs) in FIG. 1 and/or the computing device 104. The computing system 102 may communicate with the computing device 104 and/or the sensors via application programming interfaces (APIs). The computing system 102 includes a test navigation data obtaining and denoising engine 302, a lateral activity predicting engine 304, a lateral activity characterizing engine 306, a test navigation dataset generating engine 308, and one or more communication interfaces 310. FIG. 3A describes the operations of the computing system 102 consistent with FIG. 1, with additional details.

The test navigation data obtaining and denoising engine 302 is configured to obtain test navigation data (e.g., the test navigation data 202) from one or more sensors. These sensors may be disposed within an interior or an exterior of the ego vehicle, such as from the aforementioned sensors, from one or more sensors of one or more different vehicles, from one or more sensors disposed on one or more landmarks such as traffic lights, or from other sources. In some embodiments, the test navigation data obtaining and denoising engine 302 may decipher the obtained test navigation data 202 such as obtaining or deriving one or more ego vehicle characteristics or external characteristics from the sensor data. Characteristics may include statuses, attributes, or behaviors. The ego vehicle characteristics may include a distance from the center of gravity (CG) to a front axle of the ego vehicle, a distance from the center of gravity (CG) to a rear axle of the ego vehicle, a distance from the center of the front axle to the center of the rear axle of the ego vehicle, a tire distance from the CG to the rear axle of the ego vehicle, a vehicle speed, a vehicle yaw rate, vehicle sideslip angle, a front steering angle, front and rear lateral tire forces, a vehicle mass, a yaw inertia, a height of the vehicle's CG, a wheel radius, a cornering stiffness, a front axle cornering stiffness, or a rear axle cornering stiffness.

The characteristics may include operational terrain and location-dependent characteristics such as slope, camber, curvature, banking, coefficient of friction, road surface roughness, or air density. The characteristics may also include environmental and weather characteristics such as surface temperature, air temperature, wind, visibility, precipitation, icing, lighting, glare caused by sunlight angle and/or sunlight intensity, electromagnetic interference, clutter, vibration, other sources of sensor noise, and/or seasonal changes such as a higher concentration of foliage on roads during winter. The characteristics may include infrastructural characteristics such as road types, lane markings, barriers traffic signals, and traffic signage. The infrastructural characteristics may also include availability and placement of operational infrastructure. Operational infrastructure may include operational surfacing, navigation aids such as beacons, lane markings, and/or augmented signage, traffic management devices such as traffic lights, right-of-way signage, vehicle running lights, keep-out zones, special road use rules such as time-dependent lane direction changes, and vehicle-to-infrastructure availability. The operational infrastructure may include permanent obstacles such as structures, curbs, median dividers, guard rails, trees, bridges, tunnels, berms, ditches. The operational infrastructure may include temporary obstacles that are absent from high definition (HD) maps. The temporary obstacles may include transient keep-out zones, spills, falling objects, floods, water-filled potholes, landslides, washed out bridges, overhanging vegetation, and downed power lines.

The characteristics may also include traffic characteristics such as vehicle flow patterns which include average speeds of traffic, traffic densities during different times, and any shock waves. The traffic characteristics may include rules of engagement and expectations for interaction with an environment, such as traffic laws or regulations, social norms, and customary signaling and negotiation procedures with other agents, either autonomous or human. The signaling may be explicit and/or implicit via vehicle motion control. Traffic regulations may include different sign demonstrations in different countries such as blue stop signs, “right turn keep moving” stop sign modifiers, horizontal as opposed to vertical sign orientations, and side-of-road changes.

The traffic characteristics may include behavioral characteristics, such as traffic behaviors of neighboring traffic, including yielding behaviors, pedestrian movement patterns such as common pedestrian crossing points at locations besides designated crosswalks, frequency of prohibited pedestrian crossings at locations other than a crosswalk, animal movement or migration patterns, and historical accident data.

In some embodiments, the behavioral characteristics may include inferred behavioral characteristics such as predicted operational characteristics of other road users. The predicted operational characteristics may include expected behaviors of other road users which may involve a probability distribution and may be based on object classification. The expected behaviors may include or be associated with braking capabilities of other vehicles, a behavior of another vehicle such as an extent of irregularity of the other vehicle behavior, an extent of aggressiveness of the other vehicle, an extent of cooperativeness of the other vehicle, and/or whether the other vehicle has a fault. The predicted operational characteristics may include expected or predicted behaviors of persons such as an extent of cooperativeness of persons, and/or an extent of awareness of persons that a vehicle is autonomous. The predicted operational characteristics may also include identification of at-risk populations, who might be unable or exempt from following established rules and norms, such as children, injured, ability-impaired, and under-the-influence people.

The characteristics may also include communication modes, bandwidth, latency, stability, availability, and/or reliability, including both machine-to-machine communications and human interaction. The characteristics may also include availability and accuracy of infrastructure characterization data such as granularity of HD maps and identifications of temporary deviations from baseline data. These temporary deviations may include construction zones, detours, and/or temporary traffic zones such as for evacuation from emergency.

The characteristics may include identification of other road users including special purpose vehicles such as ambulances, farm equipment, construction crews, draft animals, farm animals, towing vehicles, and endangered species. The characteristics may include identification of additional equipment or lack thereof such as presence or absence of snowchains on a vehicle, which may indicate an increased probability of uncontrolled slippage or locomotion of another vehicle. The characteristics may include identification of events such as temporary structures, street dining, street festivals, parades, motorcades, and funeral processions.

The test navigation data obtaining and denoising engine 302 is configured to denoise the test navigation data 202. An example of denoising is illustrated in FIGS. 4A and 4B. In some embodiments, denoising may encompass smoothing or other filtering operations performed on the lane indicia lateral distance data. These operations may include smoothing using one or more sliding window filters to reduce noise. In some embodiments, these operations may include constructing sliding windows within the lane indicia lateral distance data, smoothing using a sliding window filter, and generating statistics within each of the sliding windows or across adjacent sliding windows. In some embodiments, the statistics may include averages, medians, or standard deviations of the distances, gradients, and deltas. In this manner, noise within the lane indicia lateral distance data is reduced or eliminated. In some embodiments, denoising may include removal of outliers.

The lateral activity predicting engine 304 is configured to predict lateral activities of the ego vehicle. In some embodiments, predicting lateral activities may include identifying potential lane indicia crossings, during which the ego vehicle performs crossing of a lane indicia, based on deltas of the generated statistics across adjacent sliding windows. For example, if the deltas across one or more adjacent sliding windows exceed a distance threshold, then the computing system 102 may predict an occurrence of one or more lane indicia crossings. In some embodiments, each predicted lateral activity may constitute a predicted lateral activity scenario. In some embodiments, predicting lateral activities may be based on one or more standard deviations, for example, across one or more lane maintaining scenarios. For example, the distance threshold may be defined relative to the one or more standard deviations. Thus, if a delta exceeds a certain number of standard deviations, then the lateral activity predicting engine 304 may predict a lane change. In other words, an occurrence of a lane indicia crossing may be predicted if, among two or more consecutive or nonconsecutive time instances, the lane indicia lateral distance data exhibits a distance difference that exceeds typical differences of a lane maintaining scenario. In some embodiments, the lateral activity predicting engine 304 may predict lateral activities based on a specific pattern of the lane indicia lateral distance data across a range of time periods.

The lateral activity characterizing engine 306 is configured to characterize the predicted lateral activity scenarios. In some embodiments, characterizing the predicted lateral activity scenarios may include verifying the predicted lateral activity scenario over the predicted lateral activity period. Verifying may include comparing the lane indicia lateral distance data corresponding to the predicted lateral activity scenario with one or more templates, as illustrated in FIGS. 5-8. In some embodiments, the templates may alternatively be used to predict the lateral activities.

In some embodiments, characterizing may include determining a direction or a type of a lane change based on a maximum or minimum distance to a lane indicia, such as a left lane indicia, over the predicted lateral activity period. In some embodiments, characterizing the predicted lateral activity scenarios may include interval adjustment which may include extending or shrinking the predicted lateral activity periods so that each lateral activity period captures an entire duration of a lateral activity scenario.

Following interval adjustment, the predicted lateral activity periods may be classified as lateral activity intervals. In some embodiments, characterizing the predicted lateral activity scenarios may include detecting a mode of the lateral activity such as whether the lateral activity scenario occurred in manual or autonomous mode. Autonomous may mean that no manual (e.g., safety driver) intervention occurred, while manual may mean that manual intervention occurred. Thus, the lateral activity intervals may be further distinguished based on manual or autonomous left or right lane changes.

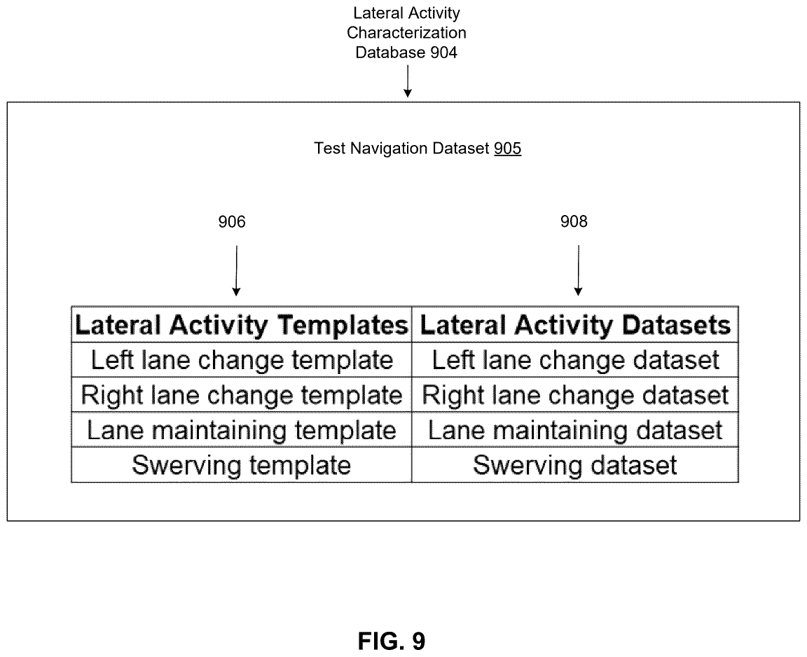

In some embodiments, the test navigation dataset generating engine 308 is configured to generate a test navigation dataset based on the characterized lateral activity scenarios. In some embodiments, generating the test navigation dataset may include augmenting the characterized lateral activity scenarios with metrics and analytics that provide contextualization of the test navigation data, as illustrated for example in FIGS. 9-12, 13A, 13B, and 14. The test navigation dataset may be leveraged to improve subsequent ego vehicle verification and validation, and improve safety of deployment.

The communication interfaces 310 may include APIs and be configured to communicate between the computing system 102, the ego vehicle, and any other external sources. For example, the communication interfaces 310 may be configured to communicate with one or more sensors to obtain the sensor data, and communicate with physical ego vehicle components in order to maneuver the ego vehicle.

FIG. 3B illustrates an example implementation of the computing system 102 that obtains the lane indicia data 140, in context with other components of the ego vehicle, which may be part of the computing system 102 or separate from the computing system 102. The other components may provide the localization data 140 and the perception data 160, as part of the test navigation data 202. In some embodiments, FIG. 3B provides further contextual information and may be implemented in conjunction with FIG. 1, FIG. 2, and FIG. 3A. The test navigation data 202 may include raw and/or processed data, and may be manifested in different formats, including textual data, media data, binary data, unstructured data, and/or structured data. The other components may include a prediction source 350, a planning source 360, a perception source 370, a control source 380, a localization source 390, and/or a router 362.

The perception source 370 may be implemented as part of the test navigation data obtaining and denoising engine 302, the lateral activity predicting engine 304 or the lateral activity characterizing engine 306. To summarize, the perception source 370 may output or generate the perception data 160, which may include lane indicia, from perception sensors 372, which may include sensors of different modalities including any of Lidar, camera, radar, ultrasonic, sonar, and/or far infrared (FIR) sensors as mentioned in FIG. 1. The perception sensors 372 may work in conjunction with any localization sensors 392. The localization sensors may provide the localization data 140. Together, the perception data 160 and the localization data 140 may constitute the test navigation data 202. The perception source 370 may combine, merge, or fuse data from different modalities. The perception source 370 may perform entity recognition (e.g., lane indicia recognition, occupant recognition), for example, based on semantic segmentation and/or instance segmentation. The perception source 370 may thus recognize lane indicia, occupants, and attributes thereof, including locations and characteristics of the lane indicia and occupants.

The perception source 370 may provide certain outputs within the perception data 160 to the prediction source 350 and/or the planning source 360. In some embodiments, the prediction source 350 may predict one or more trajectories and/or behaviors of occupants that were captured by the perception source 370. The prediction source 350 may feed or provide outputs to the planning source 360.

The planning source 360 may plan one or more actions, such as navigation or locomotive actions which may encompass planning a route based on the outputs from the perception source 370 and/or the prediction source 350, and/or planning actuation-related actions such as changing lanes, braking, and/or accelerating, or controlling modes such as cruise control (e.g., adaptive cruise control, intelligent cruise control). The planning source 360 may obtain outputs of a remote assistance source 357 which may be external to the ego vehicle. For example, the planning source 360 may obtain indications of remote operations such as tele assistance or teleoperations, and accordingly modify plans. The control source 380 may receive outputs from the planning source 360. The control source 380 may implement any of, or a subset (e.g., a portion) or all of the actions planned by the planning source 360.

The localization source 390 may obtain information from localization sensors 392, from the perception sensors 372, and/or geospatial information such as a map 391. In some embodiments, at least a portion of, or an entirety of, the geospatial information may be unavailable. The localization sensors 392 may include global navigation satellite system (GNSS) sensors, inertial measurement unit (IMU), accelerometers, gyroscopes, and magnetometers, which may identify a current location of the ego vehicle. The map 391 may include a standard definition (SD) map or a high definition (HD) map. The computing system 102 may, as a sanity check, compare one or more outputs of the perception sensors 372 to any entities, such as static entities, on the map 391. For example, if the map 391 illustrates an entity such as a traffic sign at a particular location but that entity is undetected by the perception sensors 372, the computing system 390 may determine a possible failure, malfunction, and/or lack of calibration of the perception sensors 372. The computing system 102 may either transmit this indication of a potential issue to the perception sensors 372 or to a controller area network (CAN) agent 381.

The control source 380 may be connected to the CAN agent 381, which may be part of or include a CAN bus. The CAN agent 381 may communicate with other controllers (e.g., microcontrollers) and devices associated with the ego vehicle, and/or may generate reports pertaining to ego vehicle operations and statuses. The router 362 may provide connection to other external entities and/or may create a vehicle area network (VAN). Meanwhile, an HMI input 358, which may be obtained from the computing device 104, may provide a mission 359 which includes an intended destination.

FIG. 4A illustrates an example implementation of the computing system 102, specifically, the test navigation data obtaining and denoising engine 302. In FIG. 4A, lane indicia lateral distance data 402 may be part of the test navigation data 202 or may be derived from the test navigation data 202. In some embodiments, the lane indicia lateral distance data 402 may include time series data, of lateral distance measurements from the ego vehicle (e.g., a center of mass of the ego vehicle or other position defined with respect to the ego vehicle) to a lane indicia, such as an adjacent right lane boundary or an adjacent left lane boundary with respect to the ego vehicle. The lane indicia lateral distance data 402 shows the lateral distance measurements at different, consecutive time instances. Time instances may refer to specific points in time at which measurements are obtained or derived. Consecutive time instances refer to successive points in time. For example, if measurements are obtained or derived every 0.5 seconds, then consecutive time instances may be at 0 seconds, 0.5 seconds, 1 second, 1.5 seconds, 2 seconds, 2.5 seconds, and so on. Time instances of 0 seconds and 1 second, for example, would be nonconsecutive. In some embodiments, time periods or time intervals may refer to a specific range of times, such as from 0 seconds to 0.5 seconds. Consecutive time periods may refer to nonoverlapping and adjacent or successive time periods, such as from 0 seconds to 0.5 seconds and from 0.5 seconds to 1 second.

Here, the lateral distance data 402 includes lateral distance measurements at time instances t₁, t₂, t₃, t₄, t₅, t₆, t₇, and t₈. A large lateral distance at a given time instance, followed by a small lateral distance at a consecutive time instance, may signify a lane change. Assume that the lateral distance measurements are with respect to an adjacent right lane indicia. Right before the ego vehicle crosses a lane indicia (e.g., to a left of the adjacent right lane indicia), the lateral distance to the adjacent right lane indicia is large. Right after the ego vehicle crosses the lane indicia, the lateral distance becomes small because the lateral distance is now measured with respect to the lane indicia, which has become the adjacent right indicia with respect to the ego vehicle.

The test navigation data obtaining and denoising engine 302 may perform denoising by constructing sliding windows. Constructing of the sliding windows commences with constructing a first time window from t₁ to t₃ and then shifting the constructed time window, and each subsequently constructed time window, until an end of the measuring period. For example, the first time window from t₁ to t₃ is shifted, resulting in a second time window from t₂ to t₄. The second time window is shifted, resulting in a third time window from t₃ to t₅. The third time window is shifted, resulting in a fourth time window from t₄ to t₆. The fourth time window is shifted, resulting in a fifth time window from t₅ to t₇. The fifth time window is shifted, resulting in a sixth time window from t₆ to t₈. Here, for exemplary purposes, each time window spans three consecutive time instances. It is understood that a time window may span any number of time instances. Additionally, here, for exemplary purposes, each shift between two consecutive time windows is by an amount of a single measuring period. It is understood that each shift may be by same or different number of measuring periods.

Within each time window, or across different time windows the test navigation data obtaining and denoising engine 302 generates denoised lane indicia lateral distance data. This may include obtaining statistics such as averages, medians, or standard deviations of the distances, gradients, and deltas of the lateral distances. For exemplary purposes, in FIG. 4A, the test navigation data obtaining and denoising engine 302 obtains an average lateral distance within each time window. For example, within the time window t₁ to t₃, the test navigation data obtaining and denoising engine 302 obtains an average lateral distance across the time instances t₁, t₂ and t₃ by averaging 3.11, 3.12, and 3.21. By a similar principle, within the time window t₂ to t₄, the test navigation data obtaining and denoising engine 302 obtains an average lateral distance across the time instances t₂, t₃ and t₄ by averaging 3.12, 3.21 and 3.31. By a similar principle, within the time window t₃ to t₅, the test navigation data obtaining and denoising engine 302 obtains an average lateral distance across the time instances t₃, t₄ and t₅ by averaging 3.21, 3.31 and 1.68. By a similar principle, within the time window t₄ to t₆, the test navigation data obtaining and denoising engine 302 obtains an average lateral distance across the time instances t₄, t₅ and t₆ by averaging 3.31, 1.68 and 3.42. By a similar principle, within the time window t₅ to t₇, the test navigation data obtaining and denoising engine 302 obtains an average lateral distance across the time instances t₅, to and t₇ by averaging 1.68, 3.42, and 3.49. By a similar principle, within the time window t₆ to t₈, the test navigation data obtaining and denoising engine 302 obtains an average lateral distance across the time instances t₄, t₅ and t₆ by averaging 3.42, 3.49 and 2.13. In this manner, noise within the lane indicia lateral distance data 402 is reduced or eliminated. In some embodiments, test navigation data obtaining and denoising engine 302 may perform additional or alternative operations on the lane indicia lateral distance data 402 such as removal of outliers or normalization across lanes of different widths.

FIG. 4B illustrates an example implementation of the computing system 102, specifically, the test navigation data obtaining and denoising engine 302. In FIG. 4B, lane indicia lateral distance data 404 may be part of the test navigation data 202 or may be derived from the test navigation data 204. In some embodiments, the lane indicia lateral distance data 404 may include time series data, of lateral distance measurements from the ego vehicle (e.g., a center of mass of the ego vehicle or other position defined with respect to the ego vehicle) to a lane indicia, such as a right lane boundary or a left lane boundary. The lane indicia lateral distance data 404 shows the lateral distance measurements at different, consecutive time instances.

Here, the lateral distance data 402 includes lateral distance measurements at time instances t₁, t₂, t₃, t₄, t₅, t₆, t₇, and t₈. The test navigation data obtaining and denoising engine 302 may perform denoising by constructing sliding windows. FIG. 4B illustrates an implementation in which consecutive sliding windows are shifted by different number of measuring periods. In particular, some shifts between consecutive time windows are by a single measuring period while one shift (e.g., from between t₁ and t₂ to between t₃ and t₄) is by two measuring periods.

Constructing of the sliding windows commences with constructing a first time window from t₁ to t₂ and then shifting the constructed time window, and each subsequently constructed time window, until an end of the measuring period. For example, the first time window from t₁ to t₂ is shifted, resulting in a second time window from t₃ to t₄. Here, the shift between the first time window and the second time window is by two measuring periods, instead of a single measuring period. This may be attributed to the large difference in lateral distances between time instances t₂ and t₃ which may signify a lane change. It may be misleading to take an average between lateral distances at time instances t₂ and t₃, so a single time window that includes both times t₂ and t₃ may be avoided. In some embodiments, as shown in the example of FIG. 4B, an amount of the shift may depend on an amount of a difference in lateral distances between two consecutive time instances.

The second time window is shifted, resulting in a third time window from t₄ to t₅. The third time window is shifted, resulting in a fourth time window from t₅ to t₆. The fourth time window is shifted, resulting in a fifth time window from t₆ to t₇. The fifth time window is shifted, resulting in a sixth time window from t₇ to t₈. Here, for exemplary purposes, each time window spans two consecutive time instances.

Within each time window, or across different time windows the test navigation data obtaining and denoising engine 302 generates denoised lane indicia lateral distance data. This may include obtaining statistics such as averages, medians, or standard deviations of the distances, gradients, and deltas of the lateral distances. For exemplary purposes, in FIG. 4B, the test navigation data obtaining and denoising engine 302 obtains an average lateral distance within each time window. For example, within the time window t₁ to t₂, the test navigation data obtaining and denoising engine 302 obtains an average lateral distance across the time instances t₁, t₂ by averaging 3.42 and 3.49. By a similar principle, within the time window t₃ to t₄, the test navigation data obtaining and denoising engine 302 obtains an average lateral distance across the time instances t₃ and t₄ by averaging 0.02 and 0.08. By a similar principle, within the time window t₄ to t₅, the test navigation data obtaining and denoising engine 302 obtains an average lateral distance across the time instances t₄ and t₅ by averaging 0.08 and 0.25. By a similar principle, within the time window t₅ to t₆, the test navigation data obtaining and denoising engine 302 obtains an average lateral distance across the time instances t₅ and t₆ by averaging 0.25 and 0.34. By a similar principle, within the time window t₆ to t₇, the test navigation data obtaining and denoising engine 302 obtains an average lateral distance across the time instances t₅, t₆ and t₇ by averaging 0.34 and 0.45. By a similar principle, within the time window t₇ to t₈, the test navigation data obtaining and denoising engine 302 obtains an average lateral distance across the time instances t₇ and t₈ by averaging 0.45 and 0.5. In this manner, noise within the lane indicia lateral distance data 404 is reduced or eliminated.

FIGS. 5-8 illustrate lateral activity scenario templates used to predict or characterize lateral activities. In some embodiments, the lateral activity characterizing engine 306 may compare lane indicia lateral distance data with any of the lateral activity scenario templates in order to characterize a lateral activity corresponding to the lane indicia lateral distance data. If the lane indicia lateral distance data sufficiently conforms to any of the templates, then the lane indicia lateral distance data may be characterized as a lateral activity corresponding to the conforming template. In some embodiments, sufficiently conforming may mean exhibiting a same general pattern (e.g., having consecutive increasing segments or consecutive decreasing segments that are discontinuous) over a predicted lateral activity time period. In some embodiments, additionally or alternatively, sufficiently conforming may mean that at a discontinuity time instance corresponding to the discontinuity, the lateral distance approaches zero or within a threshold range of zero. The discontinuity time instance may refer to a time instance at which the discontinuity occurs. The threshold range may be defined based on a maximum lateral distance of the particular ego vehicle at any time instance. In some embodiments, additionally or alternatively, sufficiently conforming may mean that at a certain time instance before or after the discontinuity time instance, the lateral distance reaches some nonzero value. In some embodiments, criteria for predicting or characterizing lateral activities include a minimum consecutive crossing count within the lane indicia lateral distance data in order for a lateral activity to be predicted or characterized. In some embodiments, a crossing may include a discontinuity, in which a lateral distance immediately following the discontinuity starts at or near zero.

FIG. 5 illustrates a left lane change template 501, which includes left lane change scenario template data 502 and lane indicia lateral distance template data 542. The left lane change template 501, the left lane change scenario template data 502 and lane indicia lateral distance template data 542 may constitute a portion of the test navigation data 202. In some embodiments, the left lane change scenario template data 502 includes a representation, such as a pictorial representation of a left lane change scenario. For example, the left lane change scenario template data 502 may include an ego vehicle 512, an initial right lane indicia 522, and an initial left lane indicia 532. The initial right lane indicia 522 and the initial left lane indicia 532 are defined with respect to an initial position of the ego vehicle 512 at a time t₁. It is understood that, following a left lane change, the initial left lane indicia 532 will become an updated right lane indicia, to a right of the ego vehicle 512, at a time t₃.

The ego vehicle 512 is depicted in a left lane change scenario during a left lane change time period between t₁ and t₃. Initially, at a time instance t₁, a distance from the ego vehicle 512 (e.g., a center of mass of the ego vehicle 512) to an adjacent right lane indicia (e.g., the initial right lane indicia 522) is d₁. During a first left lane change segment time period between t₁ and t₂ the ego vehicle 512 is laterally moving to the left direction, towards the initial left lane indicia 532, but has not crossed the initial left lane indicia 532. At time instance t₂ a position of the ego vehicle 512 is at the initial left lane indicia 532. During a second left lane change segment time period between t₂ and t₃ the ego vehicle 512 is laterally moving to the left direction, after crossing the initial left lane indicia 532, and continues to move away from the initial left lane indicia 532 until arriving at or near a center of the new lane, which is bounded by an updated left lane indicia 537 and the updated right lane indicia 532.

The lane indicia lateral distance template data 542 depicts a lateral distance between the ego vehicle 512 and a nearest adjacent right lane indicia with respect to a current position of the ego vehicle 512. The lane indicia lateral distance template data 542 is temporally aligned with the left lane change scenario template data 502. During the first left lane change segment time period between t₁ and t₂ the lateral distance increases from d₁ to d₂, as shown via a first segment 544 (e.g., first left lane change segment). The lateral distance, as previously alluded to, is defined from the ego vehicle 512 to the initial right lane indicia 522 during the aforementioned time period. Although the first segment 544 is shown as linearly increasing for the sake of example, in some embodiments, the manner of increase may be nonlinear. At time instance t₂between the first left lane change segment time period and the second left lane change segment time period, the lane indicia lateral distance template data 542 exhibits a discontinuity. During the second left lane change segment time period between t₂ and t₃ the lateral distance increases from 0 to d₁, as shown via a second segment 546 (e.g., second left lane change segment). During the second left lane change segment time period, the lateral distance is defined from the ego vehicle 512 to the initial left lane indicia 532. This is because the nearest adjacent right lane indicia to the ego vehicle 512 has been updated to the initial left lane indicia 532, after the ego vehicle 512 has crossed the initial left lane indicia 532. Although the second segment 546 is shown as linearly increasing for the sake of example, in some embodiments, the manner of increase may be nonlinear.

The lane indicia lateral distance template data 542 is generated under assumptions that the original lane bounded by the initial right lane indicia 522 and the initial left lane indicia 532 has a same width as the new lane, and that for a left lane change scenario to be completed, the ego vehicle 512 is required to arrive at or near a center of the new lane following the left lane change scenario. However, if either assumption is modified, then the second segment 546 may be different. For example, at time t₃, the lateral distance may not be equal to d₁.

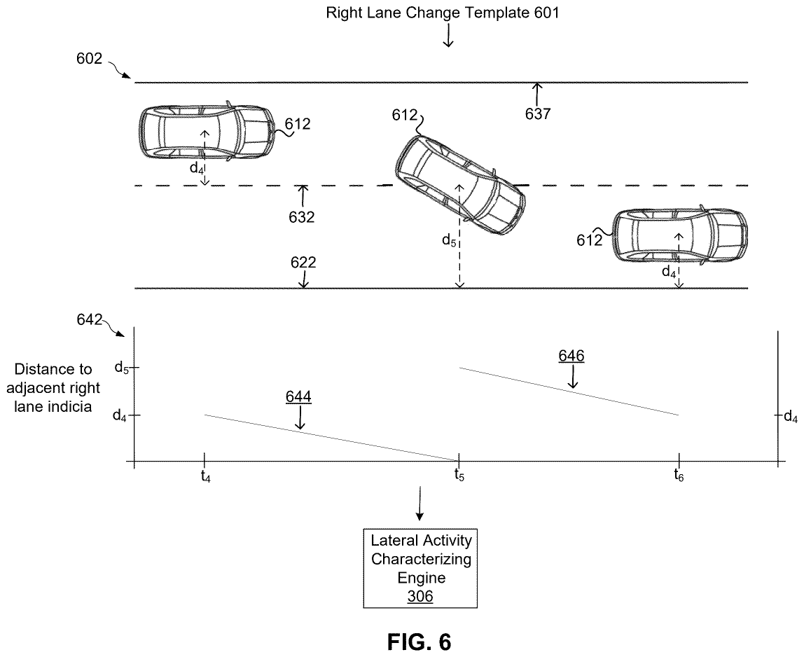

FIG. 6 illustrates a right lane change template 601, which includes right lane change scenario template data 602 and lane indicia lateral distance template data 642. The right lane change template 601, the right lane change scenario template data 602 and lane indicia lateral distance template data 642 may constitute a portion of the test navigation data 202. In some embodiments, the right lane change scenario template data 602 includes a representation, such as a pictorial representation of a right lane change scenario. For example, the right lane change scenario template data 602 may include an ego vehicle 612, an initial right lane indicia 632, and an initial left lane indicia 637. The initial right lane indicia 632 and the initial left lane indicia 637 are defined with respect to an initial position of the ego vehicle 612 at a time t₄. It is understood that, following a right lane change, the initial right lane indicia 632 will become an updated left lane indicia, which is to a left of the ego vehicle 612, at a time t₆.

The ego vehicle 612 is depicted in a right lane change scenario during a right lane change time period between t₄ and t₆. Initially, at a time instance t₄, a distance from the ego vehicle 612 (e.g., a center of mass of the ego vehicle 612) to an adjacent right lane indicia (e.g., the initial right lane indicia 632) is d₄. During a first right lane change segment time period between t₄ and t₅ the ego vehicle 612 is laterally moving to the right direction, towards the initial right lane indicia 632, but has not crossed the initial right lane indicia 632. At time instance t₅ a position of the ego vehicle 612 is at the initial right lane indicia 632. During a second right lane change segment time period between t₅ and t₆ the ego vehicle 612 is laterally moving to the right direction, after crossing the initial right lane indicia 632, and continues to move away from the initial right lane indicia 632 until arriving at or near a center of the new lane, which is bounded by an updated right lane indicia 622 and the updated left lane indicia 632.

The lane indicia lateral distance template data 642 depicts a lateral distance between the ego vehicle 612 and a nearest adjacent right lane indicia with respect to a current position of the ego vehicle 612. The lane indicia lateral distance template data 642 is temporally aligned with the right lane change scenario template data 602. During the first right lane change segment time period between t₄ and t₅ the lateral distance decreases from d₄ to 0 or approximately zero, as shown via a first segment 644 (e.g., first right lane change segment). The lateral distance, as previously alluded to, is defined from the ego vehicle 612 to the initial right lane indicia 632 during the aforementioned time period. Although the first segment 644 is shown as linearly decreasing for the sake of example, in some embodiments, the manner of increase may be nonlinear. At time instance t₅ between the first lane change segment time period and the second lane change segment time period, the lane indicia lateral distance template data 642 exhibits a discontinuity. During the second right lane change segment time period between t₅ and t₆ the lateral distance decreases from d₅ to d₄, as shown via a second segment 646 (e.g., second right lane change segment). During the second right lane change segment time period, the lateral distance is defined from the ego vehicle 612 to the updated right lane indicia 622. This is because the nearest adjacent right lane indicia to the ego vehicle 612 has been updated to the updated right lane indicia 622, after the ego vehicle 612 has crossed the initial right lane indicia 632. Although the second segment 646 is shown as linearly increasing for the sake of example, in some embodiments, the manner of increase may be nonlinear.

The lane indicia lateral distance template data 642 is generated under assumptions that the original lane bounded by the initial right lane indicia 632 and the initial left lane indicia 637 has a same width as the new lane, and that for a right lane change scenario to be completed, the ego vehicle 612 is required to arrive at or near a center of the new lane following the right lane change scenario. However, if either assumption is modified, then the second segment 646 may be different. For example, at time t₆, the lateral distance may not be equal to d₄.

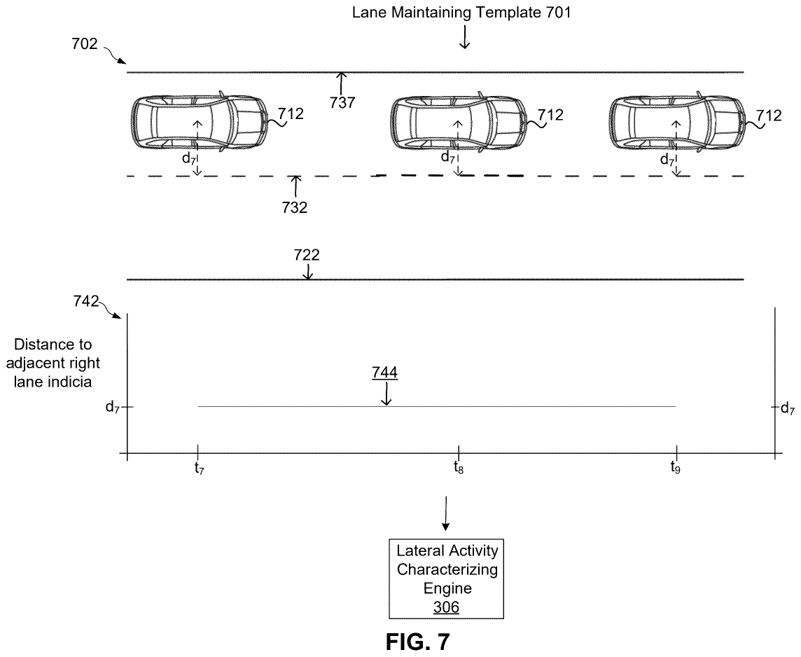

FIG. 7 illustrates a lane maintaining template 701, which includes lane maintaining scenario template data 702 and lane indicia lateral distance template data 742. The lane maintaining template 701, the lane maintaining scenario template data 702 and lane indicia lateral distance template data 742 may constitute a portion of the test navigation data 202. In some embodiments, the lane maintaining scenario template data 702 includes a representation, such as a pictorial representation of a lane maintaining scenario. For example, the lane maintaining scenario template data 702 may include an ego vehicle 712, an initial right lane indicia 732, and an initial left lane indicia 737. The initial right lane indicia 732 and the initial left lane indicia 737 are defined with respect to an initial position of the ego vehicle 712 at a time t₇. An edge right lane indicia 722 may be adjacent to the initial right lane indicia 732.

The ego vehicle 712 is depicted in a lane maintaining scenario during a lane maintaining time period between t₇ and t₉. Initially, at a time instance t₇, a distance from the ego vehicle 712 (e.g., a center of mass of the ego vehicle 712) to an adjacent right lane indicia (e.g., the initial right lane indicia 732) is d₇. At different time instances t₇, t₈ and t₉ the distance from the ego vehicle 712 to the adjacent right lane indicia remains d₇.

The lane indicia lateral distance template data 742 depicts a lateral distance between the ego vehicle 712 and a nearest adjacent right lane indicia with respect to a current position of the ego vehicle 712. The lane indicia lateral distance template data 742 is temporally aligned with the lane maintaining scenario template data 702. During the lane maintaining time period between t₇ and t₉, the lane indicia lateral distance template data 742 may be devoid of discontinuities, as shown in segment 744 (e.g., lane maintaining segment). In some embodiments, the lane maintaining template 701 may have a minimum duration, meaning that in order to be characterized as a lane maintaining scenario, a minimum lane following period is required. The lateral distance, as previously alluded to, is defined from the ego vehicle 712 to the initial right lane indicia 732 during the aforementioned time period. Although the segment 744 is shown as linear or constant for the sake of example, in some embodiments, the segment 744 may be nonconstant or nonlinear.

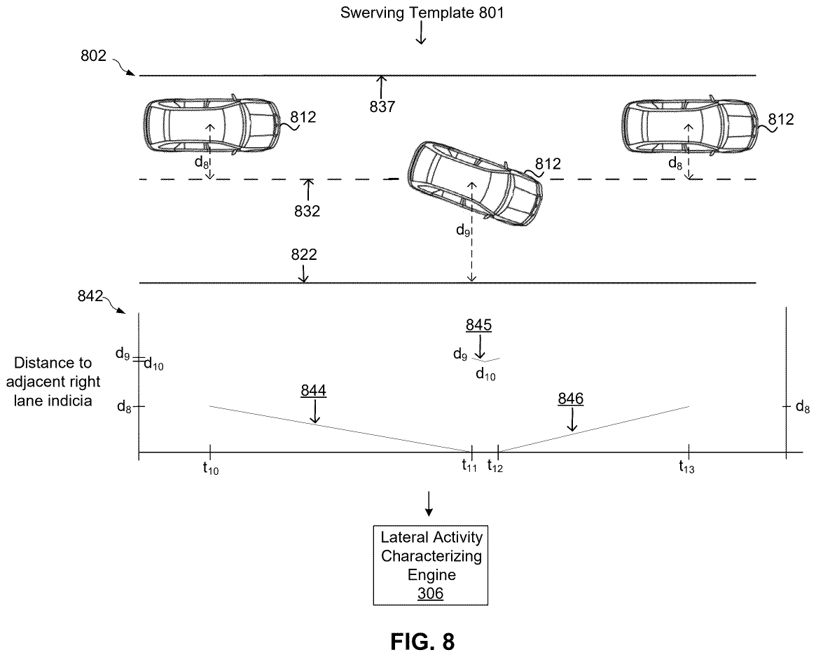

FIG. 8 illustrates a swerving template 801, which includes swerving scenario template data 802 and lane indicia lateral distance template data 842. The swerving template 801, the swerving scenario template data 802 and lane indicia lateral distance template data 842 may constitute a portion of the test navigation data 202. In some embodiments, the swerving scenario template data 802 includes a representation, such as a pictorial representation of a swerving scenario. For example, the swerving scenario template data 802 may include an ego vehicle 812, an initial right lane indicia 832, and an initial left lane indicia 837. The initial right lane indicia 832 and the initial left lane indicia 837 are defined with respect to an initial position of the ego vehicle 812 at a time t₁₀. It is understood that, in some embodiments, during swerving, the initial right lane indicia 832 will become an updated left lane indicia, which is to a left of the ego vehicle 812, during a time period between t₁₁ and t₁₂.

The ego vehicle 812 is depicted in a swerving scenario during a swerving time period between t₁₀ and t₁₃. Initially, at a time instance t₁₀, a distance from the ego vehicle 812 (e.g., a center of mass of the ego vehicle 812) to an adjacent right lane indicia (e.g., the initial right lane indicia 832) is d₈. During a first swerving time period between t₁₀ and t₁₁ the ego vehicle 812 is laterally moving to the right direction, towards the initial right lane indicia 832, but has not crossed the initial right lane indicia 832. At time instance t₁₁ a position of the ego vehicle 812 is at the initial right lane indicia 832. During a second swerving time period between t₁₁ and t₁₂ the ego vehicle 812 is in a new lane, which is bounded by an updated right lane indicia 822 and the updated left lane indicia 832. The ego vehicle 812 is initially moving towards the right direction but subsequently switching to the left direction. During a third swerving time period between t₁₂ and t₁₃ the ego vehicle 812 is moving towards the left direction.

The lane indicia lateral distance template data 842 depicts a lateral distance between the ego vehicle 812 and a nearest adjacent right lane indicia with respect to a current position of the ego vehicle 812. The lane indicia lateral distance template data 842 is temporally aligned with the right lane change scenario template data 802. During the first swerving segment time period between t₁₀ and t₁₁ the lateral distance decreases from d₈ to 0 or approximately zero, as shown via a first segment 844 (e.g., first swerving segment). The lateral distance, as previously alluded to, is defined from the ego vehicle 812 to the initial right lane indicia 832 during the aforementioned time period. Although the first segment 844 is shown as linearly decreasing for the sake of example, in some embodiments, the manner of increase may be nonlinear. At time instance t₁₁ between the first swerving segment time period and the second swerving segment time period, the lane indicia lateral distance template data 842 exhibits a discontinuity. During the second swerving segment time period between t₁₁ and t₁₂ the lateral distance decreases from d₉ to d₁₀, during which the ego vehicle 812 is travelling in the new lane and moving towards a right direction, and subsequently increases as the ego vehicle 812 switches to a left direction. This is shown via a second segment 845 (e.g., second swerving segment). During the second swerving segment time period, the lateral distance is defined from the ego vehicle 812 to the updated right lane indicia 822. This is because the nearest adjacent right lane indicia to the ego vehicle 812 has been updated to the updated right lane indicia 822, after the ego vehicle 812 has crossed the initial right lane indicia 832. Although the second segment 845 is shown as linearly increasing or decreasing for the sake of example, in some embodiments, the manner of increase or decrease may be nonlinear.

At time instance t₁₂ between the second swerving segment time period and the third swerving segment time period, the lane indicia lateral distance template data 842 exhibits a discontinuity. Time instance t₁₂ is when the ego vehicle is crossing the updated left lane indicia 832. As the ego vehicle 812 once again crosses the updated left lane indicia 832, during the third swerving segment time period between t₁₂ and t₁₃ the lateral distance increases from 0 to d₈, during which the ego vehicle 812 is travelling in the original lane and moving towards a left direction. This is shown via a third segment 846 (e.g., third swerving segment). During the third swerving segment time period, the lateral distance is defined from the ego vehicle 812 to the initial right lane indicia 832. This is because the nearest adjacent right lane indicia to the ego vehicle 812 has been updated to the initial right lane indicia 832, after the ego vehicle 812 has crossed the initial right lane indicia 832. Although the third segment 846 is shown as linearly increasing for the sake of example, in some embodiments, the manner of increase may be nonlinear.

The lane indicia lateral distance template data 842 is generated under assumptions that the ego vehicle 812 crosses over the initial right lane indicia 832, and that for a swerving scenario to be completed, the ego vehicle 812 is required to arrive at or near a center of the original lane following the swerving scenario. However, if either assumption is modified, then the second segment 845 or the third segment 846 may be different. For example, at time t₁₃, the lateral distance may not be equal to d₈. If the ego vehicle 812 returns back before crossing over the initial right lane indicia 832, then the second segment 845 may not exist.

In some embodiments, characterizing the predicted lateral activity scenarios may include interval adjustment which may include extending or shrinking the predicted lateral activity periods so that each lateral activity period captures an entire duration of a lateral activity scenario. In some embodiments, the interval adjustment is based on standard deviations of deltas. For example, during a potential lane change interval, deltas between consecutive sliding windows are evaluated and compared to typical (e.g., mean) deltas between consecutive sliding windows during lane maintaining scenarios. If the deltas deviate by at least a threshold extent, then the potential lane change interval may be characterized as part of a lane change scenario. The threshold extent may be defined based on the standard deviations of deltas during lane maintaining scenarios. In some embodiments, the interval adjustment may be limited by maximum index extension limits such as a maximum duration, such that a lane change scenario cannot consume more than a maximum duration of time.

FIG. 9 illustrates an example lateral activity characterization database 904, which may store one or more test navigation datasets 905 which may include one or more files. In some embodiments, the test navigation datasets 905 may include any of the test navigation data 202. In some examples, the lateral activity characterization database 904 may store lateral activity templates 906, which may include any of the left lane change template 501, the right lane change template 601, the lane maintaining template 701, and the swerving template 801. The lateral activity characterization database 904 may store lateral activity datasets 908, which include any lane indicia lateral distance data, and corresponding sensor data or contextual information, associated with any lateral activity scenarios that include left lane change, right lane change, lane maintaining, and swerving. In some embodiments, the lateral activity characterization database 904 stores test navigation datasets 905 for only a single ego vehicle. In other embodiments, the lateral activity characterization database 904 stores test navigation datasets for different vehicles, including the ego vehicle and ado vehicles. The lateral activity characterization database 904 may be organized according to different folders or directories.

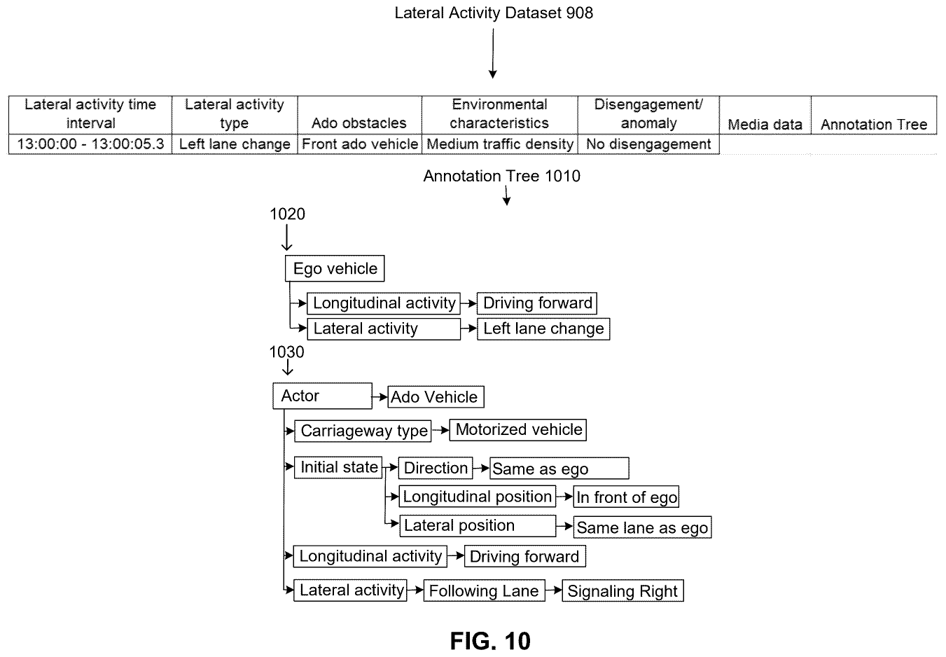

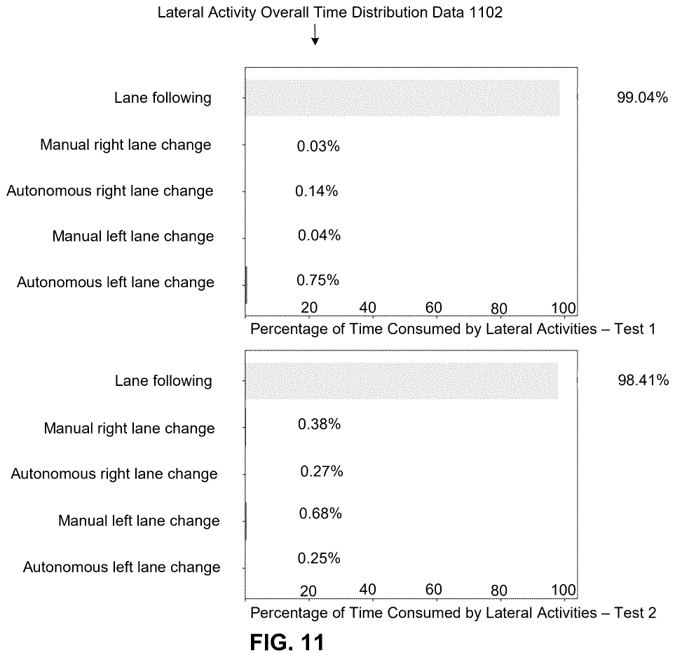

FIG. 10 illustrates an example lateral activity dataset 908. In some embodiments, the lateral activity dataset 908 contains lateral activity scenario data of each lateral activity scenario. The lateral activity scenario data may contain a lateral activity time interval, which may include a full duration of time from a start of the lateral activity scenario to an end of the lateral activity scenario. The lateral activity scenario data may contain a lateral activity type, which includes a type of lateral activity, such as a right lane change, a left lane change, a swerving, or lane maintaining. The lateral activity scenario data may contain any ado obstacles within a threshold distance of the ego vehicle during the lateral activity time interval. The lateral activity scenario data may include one or more ego vehicle characteristics or external characteristics such as environmental characteristics and ado characteristics. Any of the aforementioned characteristics may include the characteristics as described previously with respect to FIG. 3A. The ego vehicle characteristics may include statuses of the ego vehicle, such as an existence or absence of a disengagement or other anomalous condition. The external characteristics may include an existence of certain occupants such as ado vehicles and relative positions of the occupants with respect to the ego vehicle. The lateral activity scenario data may further include any captured media data, such as images or video of the lateral activity scenario. In some embodiments, the lateral activity scenario data may include an annotation tree 1010 or other structured or organized format or data structure that encapsulates the lateral activity scenario. The annotation tree 1010 may include a hierarchical format. The annotation tree 1010 may contain data structures 1020 and 1030. For example the data structures 1020 and 1030 may contain characteristics of the ego vehicle and of an ado occupant such as an ado vehicle. These characteristics may include statuses, states, or activities. The activities may include longitudinal activities which relate to locomotion along a direction of, or parallel to, an orientation of a lane being travelled on or traversed by the ego vehicle or the ado vehicle. The activities may further include lateral activities which relate to locomotion in a perpendicular or orthogonal direction to the orientation of the lane. In some examples, for aerial vehicles, the activities may further include elevational activities that relate to locomotion perpendicular to a surface of the lane that the ego vehicle is travelling on. In some embodiments, the lateral activity dataset 908 may include metrics (e.g., lateral activity metrics) and analytics (e.g., lateral activity analytics). The metrics may include lateral activity overall time distribution data 1102, lateral activity instance duration data 1202. The analytics may include lateral activity expanded scenario relational data 1302, and lateral activity expanded scenario characterization data 1312, which are illustrated in in FIGS. 11, 12, 13A, 13B, and 14.

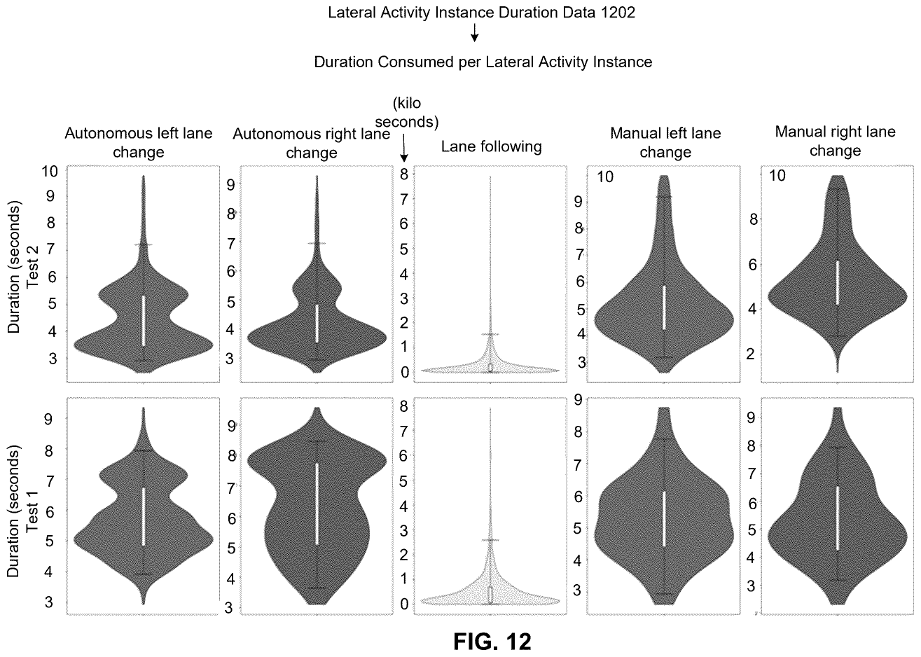

FIGS. 11 and 12 illustrate examples of lateral activity metrics, which include the lateral activity overall time distribution data 1102 and the lateral activity instance duration data 1202. The lateral activity overall time distribution data 1102 depicts a percentage of time consumed by, or characterized by, different lateral activity types within the test navigation data 202, from different tests which may correspond to Level 4, which is augmented with a High Definition map, and Level 2 automation modes. In FIG. 11, manual and autonomous modes are distinguished. If, during a lateral activity scenario, a manual operation (e.g., by a safety driver) occurs at any time instance, then the lateral activity scenario may be characterized as a manual mode. Thus, an autonomous mode means that the entire lateral activity scenario occurred autonomously without manual intervention. Distinguishing between manual and autonomous modes means that any differences in ego vehicle characteristics between the two modes may be identified. In some embodiments, programming within the autonomous mode may be modified to more closely resemble the characteristics corresponding to the manual mode. In some embodiments, certain limitations, such as steering and actuation limitations, during the manual mode may be modified to more closely resemble the characteristics corresponding to the autonomous mode. Examples of steering and actuation limitations may include limitations of permitted steering and actuation ranges such as a maximum amount or speed at which the steering wheel may be turned or a maximum force on an actuation pedal during certain lateral activity scenarios.

For example, during a first test, 99.04% of total time while the ego vehicle was driving was characterized as lane following or lane maintaining. 0.03% of total time was characterized as a manual right lane change. 0.14% of total time was characterized as an autonomous right lane change. 0.04% of total time was characterized as a manual left lane change. 0.75% of total time was characterized as an autonomous left lane change.

For example, during a second test, 98.41% of total time while the ego vehicle was driving was characterized as lane following or lane maintaining. 0.38% of total time was characterized as a manual right lane change. 0.27% of total time was characterized as an autonomous right lane change. 0.68% of total time was characterized as a manual left lane change. 0.25% of total time was characterized as an autonomous left lane change. Left and right lane changes are separately characterized in order to infer potential biases or differences in characteristics between the different lane change directions.

The lateral activity overall time distribution data 1102 ensures that the test navigation data 202 accurately represents a diverse range of lateral maneuvers for comprehensive testing and validation. Additionally, by identifying the most frequent or safety critical lateral activities, validations may be generated or modified to prioritize the lateral activity scenarios that are most relevant or safety-critical for the autonomous driving system.

FIG. 12 illustrates example lateral activity instance duration data 1202 which depicts distributions and frequencies of durations consumed by each individual lateral activity scenario. In some embodiments, the lateral activity instance duration data 1202 includes violin plots that depict duration distribution for different lateral activities. The lateral activity instance duration data 1202 depicts probability density distributions of durations for each lateral activity type, as well as shape, spread, and central tendency of the probability density distributions. For example, the lateral activity instance duration data 1202 depicts that, for the first test, autonomous left lane changes are completed within a duration of between approximately two seconds and ten seconds, and that autonomous left lane changes most frequently consume a duration of five seconds. Here, any differences in the lateral activity instance duration data 1202 between manual mode and autonomous mode may be identified, and cause adjustment of programming in the autonomous mode or modifications of limitations or restrictions in the manual mode.

The lateral activity overall time distribution data 1102 and the lateral activity instance duration data 1202 are leveraged for lateral activity scenario identification, anomaly detection, temporal modeling, trajectory planning, and simulation-based testing. For the autonomous modes, a precision of at least 99.6% was achieved, which attests to the accuracy of predicting and characterizing lateral activities.

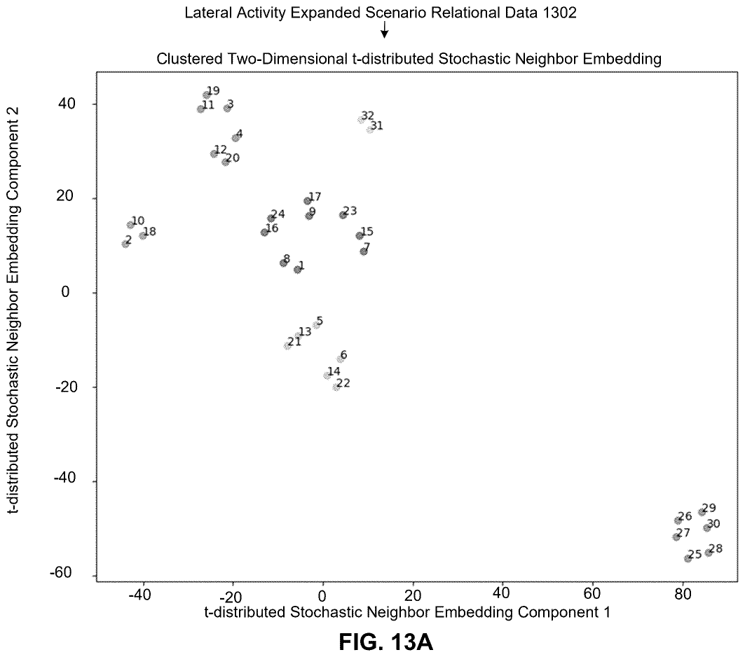

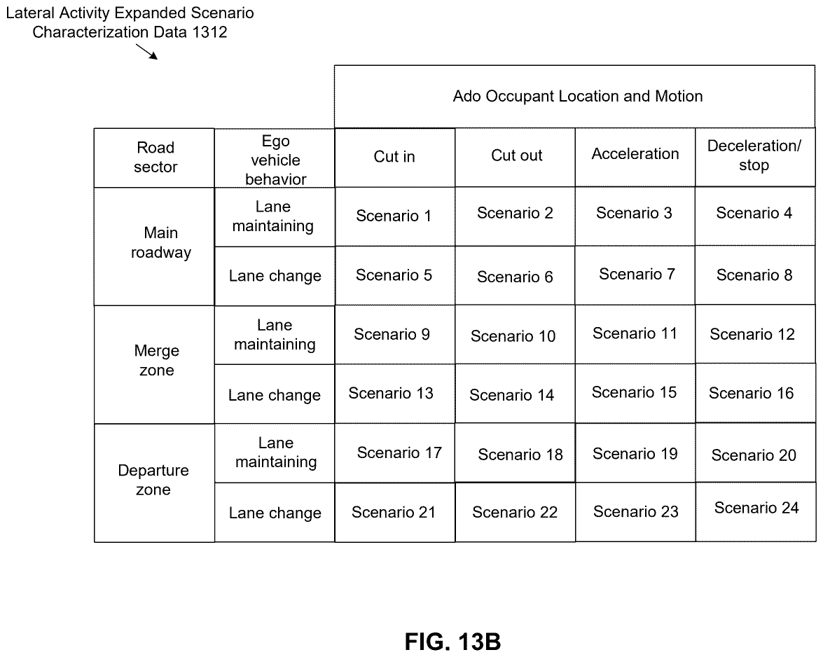

FIG. 13A illustrates example lateral activity expanded scenario relational data 1302 which depicts relationships among lateral activity expanded scenarios. In some embodiments, lateral activity expanded scenarios expand upon the aforementioned lateral activity scenarios which include lateral activities of the ego vehicle. The lateral activity expanded scenarios may additionally encompass ado occupant activities and environmental characteristics such as road sections at which the lateral activities and the ado occupant activities occur. In some embodiments, the lateral activity expanded scenarios may include additional environmental characteristics such as traffic density, road geometry, and weather conditions. Example characterizations of the lateral activity expanded scenarios are illustrated in FIG. 13B as lateral activity expanded scenario characterization data 1312.

The computing system 102 (e.g., the test navigation dataset generating engine 308) or a different computing system may generate the lateral activity expanded scenario relational data 1302 using natural language processing and embeddings that represent the lateral activity expanded scenarios. First, if not already annotated, the computing system 102 may generate annotations within the test navigation data 202. In some embodiments, the computing system 102 may transform the annotations into a structured format such as the annotation tree 1010. Although the foregoing describes operations with respect to the annotation tree 1010, the operations may also be applicable to any structured format. The computing system 102 may transform the textual descriptions within the annotation tree 1010 into one or more numerical representations that capture semantic similarities among different lateral activity expanded scenarios or characteristics thereof. This may be achieved via word embeddings, such as Word2Vec or fastText. The word embeddings may include dense vector representations of words that encode contextual and semantic information which enable meaningful comparisons and computations. The computing system 102 may map the textual descriptions of scenarios to the word embeddings.

The word embeddings may include a high-dimensional feature space. In order to reduce computational complexity and interpretability, the computing system 102 may reduce the dimensionality of the feature space using techniques such as t-Distributed Stochastic Neighbor Embedding or Principal Component Analysis (PCA). In some embodiments, a reduced feature space may include two or three dimensions while preserving organization and relationships within the lateral activity expanded scenarios. Reduction of dimensionality improves visualization and interpretability of the lateral activity expanded scenarios, and enhances efficiency and efficacy of subsequent clustering and analysis tasks.

Using the reduced dimensionality embeddings, the computing system 102 may apply clustering algorithms such as Density-Based Spatial Clustering of Applications with Noise (DBSCAN) to group together similar lateral activity expanded scenarios. The clustering algorithms leverage proximity and density of the embeddings to discover related lateral activity expanded scenarios, without requiring prior knowledge of the numbers of clusters. By applying the clustering algorithms, the computing system 102 generates a cluster map or other proximity representation which depicts the degrees of proximity (e.g., extent of similarity) among the lateral activity expanded scenarios. The degrees of proximity may be associated with cosine similarities of the reduced dimensionality embeddings. The resulting cluster map provides insights regarding patterns, outliers, and potentially overlooked edge scenarios. The resulting cluster map encompasses a wide diversity of scenarios including complex scenarios. This clustering approach effectively mines latent characteristics and relationships thereof between the lateral activity expanded scenarios.

The resulting cluster map may be leveraged for targeted training and testing of autonomous vehicle systems. For example, in order to obtain training datasets that are diverse with respect to one another, a subset of lateral activity expanded scenarios that are farther away from one another within the cluster map may be extracted. The cluster map may also highlight gaps or underrepresented scenarios. As a result, synthetic scenarios may be generated to provide more comprehensive coverage.

In FIG. 13A, a proximity between lateral activity expanded scenarios correlates to a degree of similarity between the lateral activity expanded scenarios. FIG. 13A illustrates lateral activity expanded scenarios 1 through 24 which are derived from an International Organization for Standardization (ISO) 34504 standard and lateral activity expanded scenarios 25-32 which are artificially generated. Lateral activity expanded scenarios 25 to 30 are additional lateral activity expanded scenarios involving the ego vehicle following a lane, performing a left lane change, and performing a right lane change, either on a highway or on a ramp, respectively. Lateral activity expanded scenarios 31 and 32 include vehicle pedestrian scenarios corresponding to lateral activity expanded scenarios 1 and 2.

In FIG. 13A, the lateral activity expanded scenarios may be clustered into six distinct categories. Initially, depending on a number of occupants including the ego vehicle, the lateral activity expanded scenarios are clustered into occupant-based categories: single-occupant scenarios, two-occupant scenarios, and three-occupant scenarios. The two-occupant scenarios are further clustered into additional behavior-based categories: both occupants following a same lane indicia, one occupant, either the ego vehicle or the ado vehicle, is changing lanes, and where both occupants are at least partially simultaneously changing lanes. At least some of the categories may include pedestrian, animal, or other occupant interactions.

As an illustrative example, the lateral activity expanded scenarios 2, 10, and 18 are clustered in close proximity which indicates that they are closely related. As illustrated in FIG. 13B, the lateral activity expanded scenario 2 corresponds to the ego vehicle maintaining a same lane while an ado occupant is cutting out within a main roadway. The lateral activity expanded scenario 10 corresponds to the ego vehicle maintaining a same lane while an ado occupant is cutting out within a merge zone. The lateral activity expanded scenario 18 corresponds to the ego vehicle maintaining a same lane while an ado occupant is cutting out within a departure zone.

FIG. 13B illustrates example lateral activity expanded scenario characterization data, which describes ego vehicle activities, ado occupant activities, and locations in which the ego vehicle activities and ado occupant activities occur for each lateral activity expanded scenario 1-24 that is illustrated in FIG. 13A.

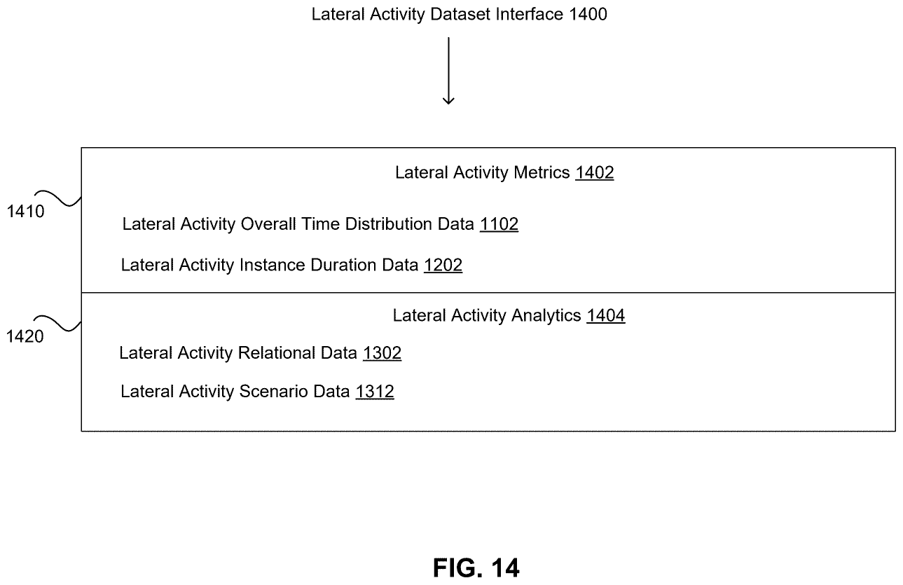

FIG. 14 illustrates a lateral activity dataset interface 1400, in which lateral activity metrics 1402 and lateral activity analytics 1404 may be presented. The lateral activity dataset interface 1400 may be presented on a display screen of the computing device 104. In some embodiments, the display screen may include a physical or virtual screen within an interior of the ego vehicle, or may be located outside of the ego vehicle. If within the interior of the ego vehicle, the display screen may be displayed or augmented on a windshield, dashboard, or console. The test navigation dataset generating engine 308 may generate the lateral activity dataset interface 1400. In some embodiments, the lateral activity metrics 1402 may be presented in a tab, menu, or section (hereinafter “menu”) 1410. The lateral activity analytics 1404 may be presented in a menu 1420. In some embodiments, the menus 1410 and 1420 may list the metrics 1402 and the analytics 1404, respectively. In some embodiments, each individual metric 1402 and each individual analytic 1404 may correspond to one or more applications. In some embodiments, the menus 1410 and 1420 may display, or otherwise be configured to launch, a summary that displays a limited or condensed view of the metrics 1402 and the analytics 1404. For example, the limited view of the metrics 1402 may identify the lateral activity overall time distribution data 1102 and the lateral activity instance duration data 1202. The limited view of the analytics may identify the lateral activity expanded scenario relational data 1302 and the lateral activity expanded scenario characterization data 1312. In some embodiments, any of the lateral activity overall time distribution data 1102, the lateral activity instance duration data 1202, the lateral activity expanded scenario relational data 1302 and the lateral activity expanded scenario characterization data 1312 may be selectable to launch a respective application or module, and enable a detailed version of the corresponding data to be viewed within the application. In an unlaunched state, the limited view of the metrics 1402 and the limited view of the analytics 1412 may be displayed on the lateral activity dataset interface 1400.

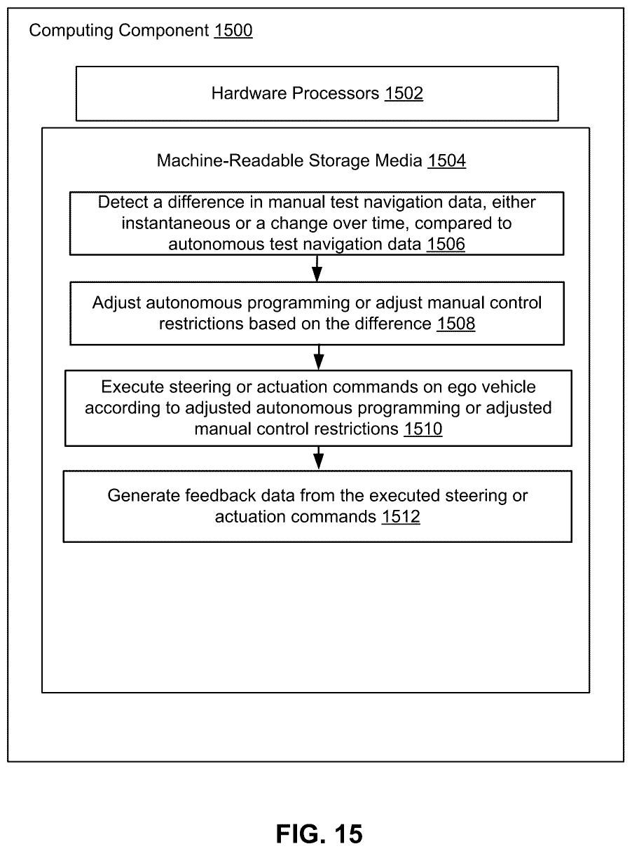

FIG. 15 illustrates a computing component 1500 that includes one or more hardware or other processors 1502 and machine-readable storage media 1504 storing a set of machine-readable/machine-executable instructions that, when executed, cause the processor(s) 1502 to perform an illustrative method of leveraging the test navigation data 202 for executing or adjusting steering or actuation commands or adjusting steering or actuation restrictions. The computing component 1500 may be implemented as the computing system 102 of FIG. 1. The processors 1502 may be implemented as the processors 103. The machine-readable storage media 1504 may be implemented as the machine-readable storage media 112, and may include suitable machine-readable storage media.

At step 1506, the processors 1502 may execute machine-readable/machine-executable instructions stored in the machine-readable storage media 1504 to compare and detect a difference between different subsets of the test navigation data 202 of the ego vehicle. For example, the different subsets may include a first subset corresponding to manual operation mode and a second subset corresponding to autonomous operation mode. Thus, in step 1506, the processors may detect a difference in manual test navigation data (e.g., the first subset) compared to the autonomous test navigation data (e.g., the second subset). In some embodiments, the comparison may be between individual time instances of corresponding manual test navigation data and autonomous test navigation data. In some embodiments, the comparison may be between entire time periods, such as evaluating a change over time, of corresponding manual test navigation data and autonomous test navigation data. In some embodiments, the processors 1502 may evaluate metrics or analytics of the first subset compared to the second subset. For example, the processors 1502 may evaluate, for a specific type of lateral activity scenario, whether a rate of disengagements or other anomalies is higher in the manual mode or the autonomous mode.

In step 1508, the processors 1502 may execute machine-readable/machine-executable instructions stored in the machine-readable storage media 1504 to adjust autonomous programming of the ego vehicle or adjust manual control restrictions of the ego vehicle based on the difference. For example, for a particular type of lateral activity scenario, if the rate of disengagements or other anomalies is higher in the manual mode, then the processors 1502 adjust manual control restrictions of the ego vehicle, to conform more closely to characteristics of the ego vehicle in the autonomous mode. Examples of restrictions may include limitations of permitted steering and actuation ranges such as a maximum amount or speed at which the steering wheel may be turned or a maximum force on an actuation pedal during certain lateral activity scenarios. If the rate of disengagements or other anomalies is higher in the autonomous mode, then the processors 1502 may adjust autonomous programming of the ego vehicle, to conform more closely to characteristics of the ego vehicle in the manual mode.

In step 1510, the processors 1502 may execute machine-readable/machine-executable instructions stored in the machine-readable storage media 1504 to execute steering or actuation commands on the ego vehicle according to adjusted autonomous programming or adjusted manual control restrictions. The executing of steering or actuation commands may cause steering or actuation components of the ego vehicle to move and perform one or more navigation actions such as speeding up, braking, changing directions, or otherwise navigating during deployment.

In step 1512, the processors 1502 may execute machine-readable/machine-executable instructions stored in the machine-readable storage media 1504 to generate feedback data from the executed steering or actuation commands. In some embodiments, the feedback data may include characteristics, such as any disengagements or other anomalies. The feedback data may be compared to certain safety thresholds. If the feedback data indicates that certain safety characteristics are outside of safety thresholds, then the processors 1502 may selectively adjust the steering or actuation commands in autonomous mode or adjust manual control restrictions.

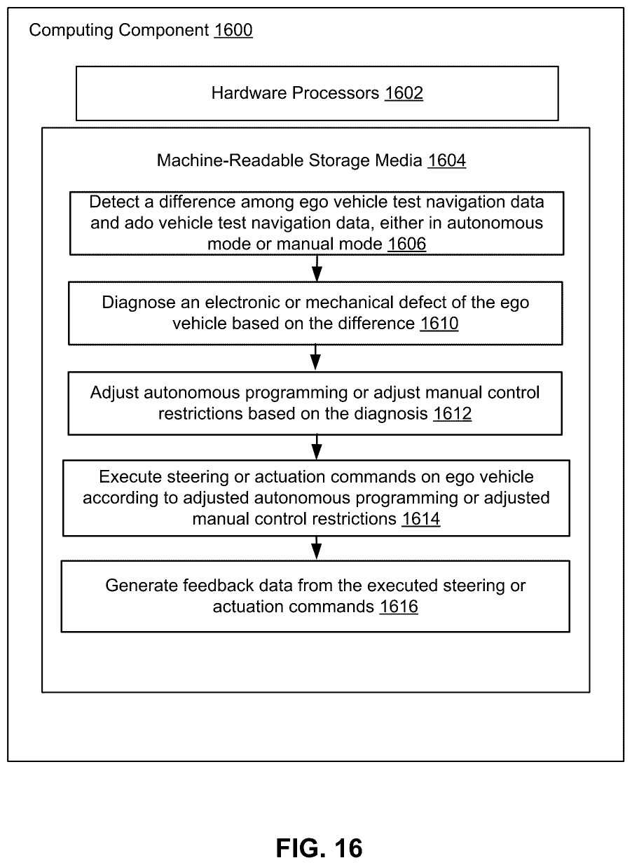

FIG. 16 illustrates a computing component 1600 that includes one or more hardware or other processors 1602 and machine-readable storage media 1604 storing a set of machine-readable/machine-executable instructions that, when executed, cause the processor(s) 1602 to perform an illustrative method of leveraging the test navigation data 202 for executing or adjusting steering or actuation commands or adjusting steering or actuation restrictions. The computing component 1600 may be implemented as the computing system 102 of FIG. 1. The processors 1602 may be implemented as the processors 103. The machine-readable storage media 1604 may be implemented as the machine-readable storage media 112, and may include suitable machine-readable storage media.

At step 1606, the processors 1602 may execute machine-readable/machine-executable instructions stored in the machine-readable storage media 1604 to compare and detect a difference between different subsets of the test navigation data 202 of the ego vehicle. For example, the different subsets may include a first subset corresponding to the ego vehicle, and a second subset corresponding to an ado occupant such as an ado vehicle. In some embodiments, the second subset may not be part of the test navigation data 202, and may be stored separately in a different database. In some embodiments, the processors 1602 may evaluate characteristics, metrics or analytics of the first subset compared to the second subset. The processors 1602 may evaluate, for a specific type of lateral activity scenario, whether certain characteristics differ between the ego vehicle and one or more ado occupants over an entire test navigation path or a common portion of the test navigation path. For example, the processors 1602 may evaluate, for a common portion of a test navigation path, a rate of disengagements or other anomalies between the ego vehicle and the one or more ado occupants.

In step 1610, the processors 1602 may execute machine-readable/machine-executable instructions stored in the machine-readable storage media 1604 to diagnose an electronic or mechanical defect of the ego vehicle based on the comparison. For example, if certain characteristics of the ego vehicle differ from those of the ado occupants over a common portion of the test navigation path, the processors 1602 may evaluate, based on one or more safety evaluations, whether the difference signifies safety issues in the ego vehicle or in the ado occupants. If the difference signifies safety issues in the ego vehicle, then the processors 1602 may diagnose that an electronic or mechanical defect of the ego vehicle does exist based on the difference.

If certain corresponding characteristics of the ego vehicle and the ado vehicles all exhibit anomalous behaviors over a common portion of the test navigation path, then the anomalous behavior may be more likely attributed to infrastructure defects such as road defects. However, if the ego vehicle characteristics exhibits anomalous behaviors while ado vehicle characteristics exhibit normal behaviors, then the anomalous behaviors may be more likely attributed to ego vehicle defects.

In step 1612, the processors 1602 may execute machine-readable/machine-executable instructions stored in the machine-readable storage media 1604 to adjust autonomous programming of the ego vehicle or adjust manual control restrictions of the ego vehicle based on the diagnosis. Steps 1614 and 1616 may be analogous to steps 1510 and 1512 in FIG. 15.

The test navigation data 202 may be leveraged in other ways. The test navigation data 202 may include, or be analyzed to identify, one or more safety characteristics for an ego vehicle under a specific set of environmental characteristics such as a road surface condition or type. Safety characteristics may include a range of particular sensor data readings that identify a safe operation of the ego vehicle. Safety characteristics may satisfy certain ranges of front and rear lateral tire forces, a front axle cornering stiffness, or a rear axle cornering stiffness, to name some nonlimiting examples.

For a different set of environmental characteristics that is not present in the test navigation data 202, the computing system 102 may iteratively determine one or more safety characteristics, using the test navigation data 202. This determination may include usage of machine learning components. For example, the specific set of environmental characteristics may include a paved, nondeformable road. The different set of environmental characteristics may include a deformable road surface such as off-roading conditions.

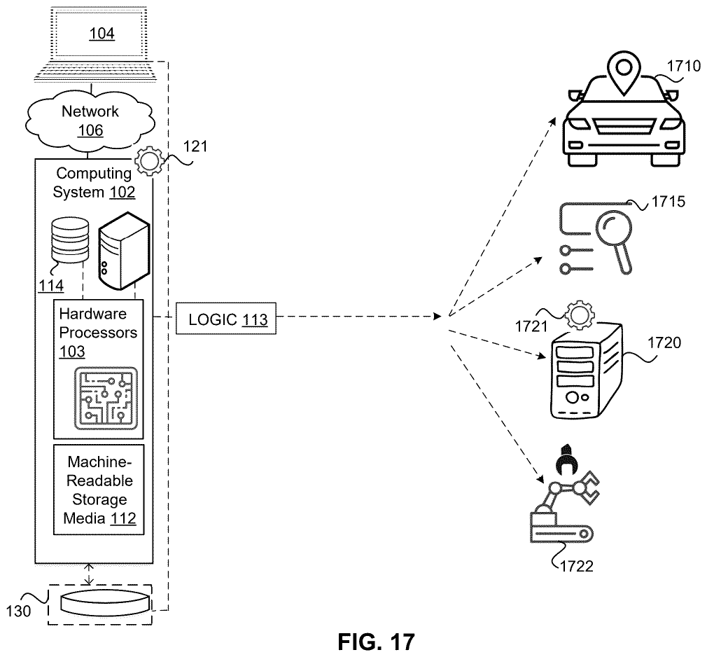

FIG. 17 illustrates certain downstream actions following the generating of the test navigation dataset, as part of a workflow or a process. As alluded to, the computing system 102 or a different computing system may implement a navigation or locomotive (e.g., actuation) action during deployment, based on the test navigation dataset.

Specifically, downstream actions may encompass performing navigation 1710, additional monitoring 1715, transmitting and/or writing information to a different computing system 1720, for example, via an API 1721, or maintenance or other physical operations 1722 such as adjusting a physical or electronic infrastructure or components of a vehicle in order to better react to certain safety conditions.

As an example of the additional monitoring 1715, the computing system 102 or a different computing system may monitor additional ego vehicle characteristics, to ensure safe operation of a vehicle, in particular, to verify whether the characteristics of the ego vehicle fall within certain operating ranges or thresholds. In some examples, the additional monitoring 1715 may occur in response to certain characteristics falling outside of certain operating ranges or thresholds. This monitoring or recording of other entity types may be performed by the computing system 102, or may be delegated to a different processor. In other examples, a downstream action may include the writing of information. Such writing of information may encompass transmission or presentation of information, an alert, and/or a notification to the computing device 104 and/or to other devices. The information may include indications of which characteristics of the ego vehicle may fall outside of operating ranges or thresholds, or reasons that an alert was triggered, and/or one or more timestamps corresponding to an originating or creation time of underlying data that caused the triggering of the alert. Alternatively, an alert may be triggered using a predicted time at which a characteristic may be predicted to fall outside of an operating range or threshold.

In other examples, a downstream action may entail an applications programming interface (API) of the computing system 102 interfacing with or calling the API 1721 of the different computing system 1720. For example, the different computing system 1720 may perform analysis and/or transformation or modification of data, through some electronic or physical operation. Meanwhile, the physical operations 1722 may include controlling braking, steering, and/or throttle components to effectuate a throttle response, a braking action, and/or a steering action during navigation.

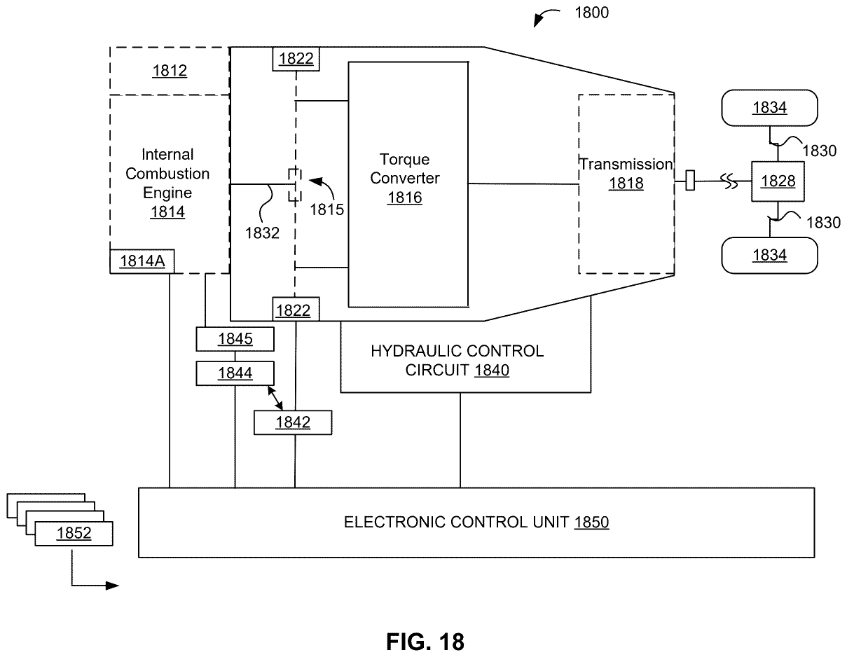

The systems and methods disclosed herein may be implemented with any of a number of different ego vehicles and ego vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 18. Although the example described with reference to FIG. 18 is a hybrid type of ego vehicle, the systems and methods for adaptive and selective extraction of media data can be implemented in other types of ego vehicles including gasoline-or diesel-powered vehicles, fuel-cell vehicles, electric vehicles, or other vehicles.

FIG. 18 illustrates a drive system of an ego vehicle 1800 that may include an internal combustion engine 1814 and one or more electric motors 1822 (which may also serve as generators) as sources of motive power. The ego vehicle 1800 may be implemented as any of the previously described ego vehicles. Driving force generated by the internal combustion engine 1814 and motors 1822 can be transmitted to one or more wheels 1834 via a torque converter 1816, a transmission 1818, a differential gear device 1828, and a pair of axles 1830.

As an HEV, ego vehicle 1800 may be driven/powered with either or both of engine 1814 and the motor(s) 1822 as the drive source for travel. For example, a first travel mode may be an engine-only travel mode that only uses internal combustion engine 1814 as the source of motive power. A second travel mode may be an EV travel mode that only uses the motor(s) 1822 as the source of motive power. A third travel mode may be an HEV travel mode that uses engine 1814 and the motor(s) 1822 as the sources of motive power. In the engine-only and HEV travel modes, ego vehicle 1800 relies on the motive force generated at least by internal combustion engine 1814, and a clutch 1815 may be included to engage engine 1814. In the EV travel mode, ego vehicle 1800 is powered by the motive force generated by motor 1822 while engine 1814 may be stopped and clutch 1815 disengaged.

Engine 1814 can be an internal combustion engine such as a gasoline, diesel or similarly powered engine in which fuel is injected into and combusted in a combustion chamber. A cooling system 1812 can be provided to cool the engine 1814 such as, for example, by removing excess heat from engine 1814. For example, cooling system 1812 can be implemented to include a radiator, a water pump and a series of cooling channels. In operation, the water pump circulates coolant through the engine 1814 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 1814. In other applications, either or both the water pump and the fan may be operated by electric current such as from battery 1844.

An output control circuit 1814A may be provided to control drive (output torque) of engine 1814. Output control circuit 1814A may include a throttle actuator to control an electronic throttle valve that controls fuel injection, an ignition device that controls ignition timing, and the like. Output control circuit 1814A may execute output control of engine 1814 according to a command control signal(s) supplied from an electronic control unit 1850, described below. Such output control can include, for example, throttle control, fuel injection control, and ignition timing control. In some embodiments, the electronic control unit 1850 may be implemented as part of any of the previously described computing systems, such as the computing system 102.

Motor 1822 can also be used to provide motive power in ego vehicle 1800 and is powered electrically via a battery 1844. Battery 1844 may be implemented as one or more batteries or other power storage devices including, for example, lead-acid batteries, nickel-metal hydride batteries, lithium-ion batteries, capacitive storage devices, and so on. Battery 1844 may be charged by a battery charger 1845 that receives energy from internal combustion engine 1814. For example, an alternator or generator may be coupled directly or indirectly to a drive shaft of internal combustion engine 1814 to generate an electrical current as a result of the operation of internal combustion engine 1814. A clutch can be included to engage/disengage the battery charger 1845. Battery 1844 may also be charged by motor 1822 such as, for example, by regenerative braking or by coasting during which time motor 1822 operate as generator.

Motor 1822 can be powered by battery 1844 to generate a motive force to move the vehicle and adjust vehicle speed. Motor 1822 can also function as a generator to generate electrical power such as, for example, when coasting or braking. Battery 1844 may also be used to power other electrical or electronic systems in the vehicle. Motor 1822 may be connected to battery 1844 via an inverter 1842. Battery 1844 can include, for example, one or more batteries, capacitive storage units, or other storage reservoirs suitable for storing electrical energy that can be used to power motor 1822. When battery 1844 is implemented using one or more batteries, the batteries can include, for example, nickel metal hydride batteries, lithium-ion batteries, lead acid batteries, nickel cadmium batteries, lithium ion polymer batteries, and other types of batteries.

An electronic control unit 1850 (described below) may be included and may control the electric drive components of the vehicle as well as other vehicle components. For example, electronic control unit 1850 may control inverter 1842, adjust driving current supplied to motor 1822, and adjust the current received from motor 1822 during regenerative coasting and breaking. As a more particular example, output torque of the motor 1822 can be increased or decreased by electronic control unit 1850 through the inverter 1842.

A torque converter 1816 can be included to control the application of power from engine 1814 and motor 1822 to transmission 1818. Torque converter 1816 can include a viscous fluid coupling that transfers rotational power from the motive power source to the driveshaft via the transmission. Torque converter 1816 can include a conventional torque converter or a lockup torque converter. In other embodiments, a mechanical clutch can be used in place of torque converter 1816.

Clutch 1815 can be included to engage and disengage engine 1814 from the drivetrain of the vehicle. In the illustrated example, a crankshaft 1832, which is an output member of engine 1814, may be selectively coupled to the motor 1822 and torque converter 1816 via clutch 1815. Clutch 1815 can be implemented as, for example, a multiple disc type hydraulic frictional engagement device whose engagement is controlled by an actuator such as a hydraulic actuator. Clutch 1815 may be controlled such that its engagement state is complete engagement, slip engagement, and complete disengagement complete disengagement, depending on the pressure applied to the clutch. For example, a torque capacity of clutch 1815 may be controlled according to the hydraulic pressure supplied from a hydraulic control circuit 1840. When clutch 1815 is engaged, power transmission is provided in the power transmission path between the crankshaft 1832 and torque converter 1816. On the other hand, when clutch 1815 is disengaged, motive power from engine 1814 is not delivered to the torque converter 1816. In a slip engagement state, clutch 1815 is engaged, and motive power is provided to torque converter 1816 according to a torque capacity (transmission torque) of the clutch 1815.

As alluded to above, ego vehicle 1800 may include an electronic control unit 1850. Electronic control unit 1850 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 1850 execute instructions stored in memory to control one or more electrical systems or subsystems in the vehicle. Electronic control unit 1850 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 18, electronic control unit 1850 receives information from a plurality of sensors included in ego vehicle 1800. For example, electronic control unit 1850 may receive signals that indicate vehicle operating conditions or characteristics, or signals that can be used to derive vehicle operating conditions or characteristics. These may include, but are not limited to accelerator operation amount, a revolution speed, of internal combustion engine 1814 (engine RPM), a rotational speed of the motor 1822 (motor rotational speed), and vehicle speed. These may also include torque converter 1816 output (e.g., output amps indicative of motor output), brake operation amount/pressure, battery state of charge (SOC) (i.e., the charged amount for battery 1844 detected by an SOC sensor). Accordingly, ego vehicle 1800 can include a plurality of sensors 1852 that can be used to detect various conditions internal or external to the vehicle (e.g., part of the sensor data 180) and provide sensed conditions to engine control unit 1850 (which, again, may be implemented as one or a plurality of individual control circuits). In one embodiment, sensors 1852 may be included to detect one or more conditions directly or indirectly such as, for example, fuel efficiency, motor efficiency, hybrid (internal combustion engine 1814+cooling system 1812) efficiency, acceleration, etc. Electronic control unit 1850 may also receive signals indicative of user behavior. Here, a user may refer to an occupant, such as a driver or a passenger. These signals may include, without limitation, a measure of head or eye movement. In some embodiments, certain user behavior may indicate anomalies in functioning of the ego vehicle 1800, which may trigger an update to the ODD.

In some embodiments, one or more of the sensors 1852 may include their own processing capability to compute the results for additional information that can be provided to electronic control unit 1850. In other embodiments, one or more sensors may be data-gathering-only sensors that provide only raw data to electronic control unit 1850. In further embodiments, hybrid sensors may be included that provide a combination of raw data and processed data to electronic control unit 1850. Sensors 1852 may provide an analog output or a digital output.

Sensors 1852 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 1852 may be within an interior or on an exterior of the ego vehicle 1850. The sensors 1852 may also include capturing sensors, which capture media data within the ego vehicle 1800 or within surroundings of the ego vehicle 1800. In some embodiments, additional sensors may not be directly connected to the ego vehicle 1800, but rather, may be located on a different entity, such as a drone or a stationary landmark such as a traffic light.

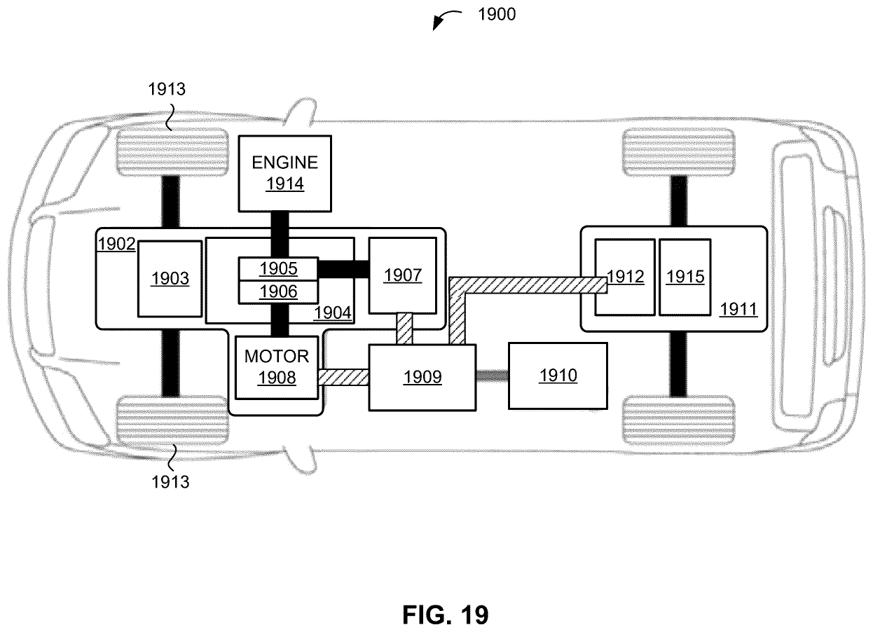

FIG. 19 is another example of an ego vehicle with which systems and methods described above can be implemented. The example illustrated in FIG. 19 is also that of a hybrid vehicle drive system of a vehicle 1900 that may also include an engine 1914 (e.g., internal combustion engine 1914) and one or more electric motors 1908, 1912 as sources of motive power. In this example, a hybrid transaxle assembly 1902 includes front differential 1903, a compound gear unit 1904, a motor 1908, and a generator 1907. Compound gear unit 1904 includes a power split planetary gear unit 1905 and a motor speed reduction planetary gear unit 1906. This example vehicle also includes front and rear drive motors 1908, 1912, an inverter with converter assembly 1909, battery 1910 (which may include multiple batteries), and a rear differential 1915. Hybrid transaxle assembly 1902 enables power from engine 1901, motor 1908, or both to be applied to front wheels 1913 via front differential 1903.

Inverter with converter assembly 1909 inverts DC power from battery 1910 to create AC power to drive AC motors 1908, 1912. In embodiments where motors 1908, 1912 are DC motors, no inverter is required. Inverter with converter assembly 1909 also accepts power from generator 1907 (e.g., during engine charging) and uses this power to charge battery 1910.

The examples of FIGS. 18 and 19 are provided for illustration purposes only as examples of vehicle systems with which embodiments of the disclosed technology may be implemented. One of ordinary skill in the art reading this description will understand how the disclosed embodiments can be implemented with vehicle platforms.

The techniques described herein, for example, are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination.

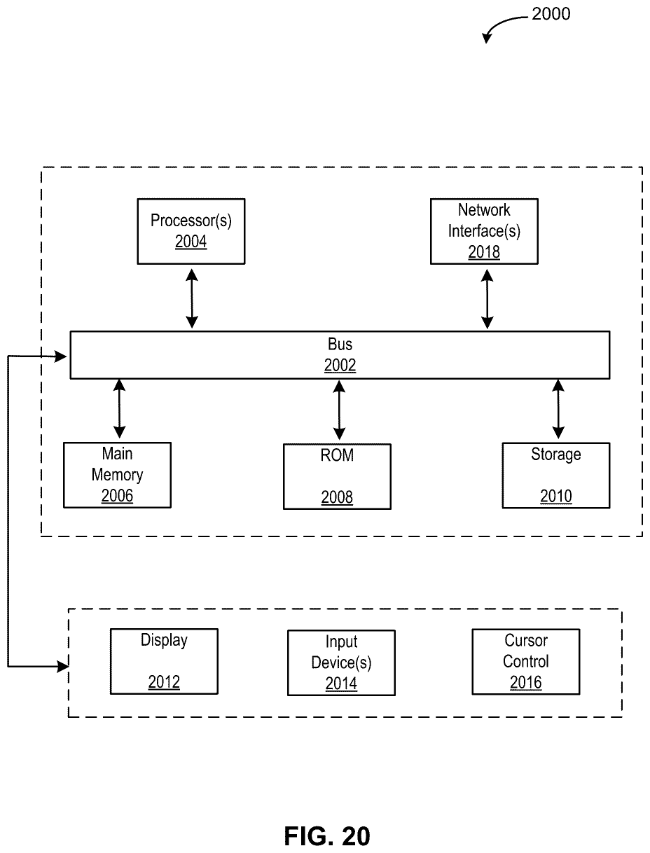

FIG. 20 illustrates a block diagram of a computer system 2000 upon which any of the embodiments described herein may be implemented. The computer system 2000 includes a bus 2002 or other communication mechanism for communicating information, one or more hardware or other processors, such as cloud processors, 2004 coupled with bus 2002 for processing information. A description that a device performs a task is intended to mean that one or more of the processor(s) 2004 performs.

The computer system 2000 also includes a main memory 2006, such as a random access memory (RAM), cache and/or other dynamic storage devices, coupled to bus 2002 for storing information and instructions to be executed by processor 2004. Main memory 2006 also may be used for storing temporary variables or other intermediate information during execution of instructions to be executed by processor 2004. Such instructions, when stored in storage media accessible to processor 2004, render computer system 2000 into a special-purpose machine that is customized to perform the operations specified in the instructions.

The computer system 2000 further includes a read only memory (ROM) 2008 or other static storage device coupled to bus 2002 for storing static information and instructions for processor 2004. A storage device 2010, such as a magnetic disk, optical disk, or USB thumb drive (Flash drive), etc., is provided and coupled to bus 2002 for storing information and instructions.

The computer system 2000 may be coupled via bus 2002 to output device(s) 2012, such as a cathode ray tube (CRT) or LCD display (or touch screen), for displaying information to a computer user. Input device(s) 2014, including alphanumeric and other keys, are coupled to bus 2002 for communicating information and command selections to processor 2004. Another type of user input device is cursor control 2016. The computer system 2000 also includes a communication interface 2018 coupled to bus 2002.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiment.

A component being implemented as another component may be construed as the component being operated in a same or similar manner as the another component, and/or comprising same or similar features, characteristics, and parameters as the another component.

Reference to a feature A “and” a feature B may be construed to also encompass the scenario of A “or” B. Reference to A “or” B may be construed to also encompass the scenario of A “and” B. Any reference to “approximate,” “close,” “near,” a “threshold” or “sufficiency” may be construed to encompass any applicable value or degree, such as any applicable value or degree sufficient to satisfy a given outcome. In some examples, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity, degree, or level may be construed as qualitatively satisfying some condition, such as presence of one or more common features. For example, a threshold level of safety may be construed as an absence of a safety-related event such as a disengagement, collision, or other accident, or not exceeding a given number or frequency of safety-related events. Reference to “likely,” “a likelihood,” or “probable” or any variation thereof may be construed as satisfying some threshold likelihood or probability. In some embodiments, a reference to two entities differing may refer to the two entities having at least a threshold range or level of difference, such as 0.01 percent, 0.1 percent, 1 percent, 5 precent, 10 percent, 20 percent, 25 percent, or any other value therebetween, or any ranges therebetween. Additionally or alternatively, a difference may be construed as qualitatively satisfying some condition or standard.

In some embodiments, a threshold distance may refer to any distance in which an obstacle may have at least a threshold likelihood or probability of affecting one or more navigation actions or characteristics of the ego vehicle. In some embodiments, a threshold distance may refer to an acceptable following distance or maintaining distance according to one or more standards, such as one or more standards governing reaction time. For example, a threshold distance may include any distances equivalent to, or less than, 3 seconds, 10 seconds, or 20 seconds of travel at a current speed, or any subranges therein.

1. A computing system comprising:
one or more processors; and
a memory storing instructions that, when executed by the one or more processors, cause the computing system to perform:
obtaining test navigation data associated with an ego vehicle;
denoising the test navigation data;
predicting lateral activity scenarios within the test navigation data;
characterizing the predicted lateral activity scenarios;
based on the characterization of the predicted lateral activity scenarios, generating a test navigation dataset; and
executing or adjusting a steering or an actuation command based on the test navigation dataset.

2. The computing system of claim 1, wherein the characterizing of the predicted lateral activity scenarios comprises characterizing each of the predicted lateral activity scenarios as a lane changing maneuver or a lane maintaining maneuver.

3. The computing system of claim 1, wherein the instructions that, when executed by the one or more processors, cause the computing system to perform:
diagnosing a navigation condition based on the test navigation dataset and based on ado test navigation datasets, where the ado test navigation datasets are associated with ado vehicles; and wherein the adjusting of the steering or actuation command is based on the diagnosis of the navigation condition.

4. The computing system of claim 1, wherein the denoising of the test navigation data comprises constructing sliding windows and generating averaged test navigation data readings within each of the constructed sliding windows.

5. The computing system of claim 1, wherein the test navigation data comprises lane indicia lateral distance data comprising lateral distances between the ego vehicle and one or more adjacent lane indicia at different time instances.

6. The computing system of claim 5, wherein the predicting of the lateral activity scenarios is based on a pattern of the lane indicia lateral distance data over a predicted lateral activity period, wherein the predicted lateral activity period comprises a time period during which a lateral activity scenario is predicted to occur.

7. The computing system of claim 6, wherein the characterizing of the lateral activity scenarios comprises characterizing a left lane change in response to the lane indicia lateral distance data exhibiting a first increasing segment and a second increasing segment, wherein the first increasing segment is discontinuous with respect to the second increasing segment, and the lateral distance between the ego vehicle and the adjacent lane indicia decreases from an end of the first increasing segment to a beginning of the second increasing segment.

8. The computing system of claim 6, wherein the characterizing of the lateral activity scenarios comprises characterizing a right lane change in response to the lane indicia lateral distance data exhibiting a first decreasing segment and a second decreasing segment, wherein the first decreasing segment is discontinuous with respect to the second decreasing segment and the lateral distance between the ego vehicle and the adjacent lane indicia increases from an end of the first decreasing segment to a beginning of the second decreasing segment.

9. The computing system of claim 1, wherein characterizing the predicted lateral activity scenarios comprises characterizing each of the predicted lateral activity scenarios as a manual lane changing maneuver or an autonomous lane changing maneuver.

10. The computing system of claim 9, wherein the instructions that, when executed by the one or more processors, cause the computing system to perform:
obtaining one or more manual lane changing metrics associated with the characterized manual lane changing maneuvers and one or more autonomous lane changing metrics associated with the characterized autonomous lane changing maneuvers; and wherein the adjusting the steering or actuation command is based on any difference between the manual lane changing metrics and the autonomous lane changing metrics.

11. A computer-implemented method comprising:
obtaining test navigation data associated with an ego vehicle;
denoising the test navigation data;
predicting lateral activity scenarios within the test navigation data;
characterizing the predicted lateral activity scenarios;
based on the characterization of the predicted lateral activity scenarios, generating a test navigation dataset; and
adjusting or executing a steering or an actuation command based on the test navigation dataset.

12. The computer-implemented method of claim 11, wherein the characterizing of the predicted lateral activity scenarios comprises characterizing each of the predicted lateral activity scenarios as a lane changing maneuver or a lane maintaining maneuver.

13. The computer-implemented method of claim 11, further comprising:
diagnosing a navigation condition based on the test navigation dataset and based on ado test navigation datasets, where the ado test navigation datasets are associated with ado vehicles; and wherein the adjusting of the steering or actuation command is based on the diagnosis of the navigation condition.

14. The method of claim 11, wherein the denoising of the test navigation data comprises constructing sliding windows and generated averaged test navigation data readings within each of the constructed sliding windows.

15. The method of claim 11, wherein the test navigation data comprises lane indicia lateral distance data comprising lateral distances between the ego vehicle and one or more adjacent lane indicia at different time instances.

16. The method of claim 15, wherein the predicting of the lateral activity scenarios is based on a pattern of the lane indicia lateral distance data over a predicted lateral activity period, wherein the predicted lateral activity period comprises a time period during which a lateral activity scenario is predicted to occur.

17. The method of claim 16, wherein the characterizing of the lateral activity scenarios comprises characterizing a left lane change in response to the lane indicia lateral distance data exhibiting a first increasing segment and a second increasing segment, wherein the first increasing segment is discontinuous with respect to the second increasing segment, and the lateral distance between the ego vehicle and the adjacent lane indicia decreases from an end of the first increasing segment to a beginning of the second increasing segment.

18. The method of claim 16, wherein the characterizing of the lateral activity scenarios comprises characterizing a right lane change in response to the lane indicia lateral distance data exhibiting a first decreasing segment and a second decreasing segment, wherein the first decreasing segment is discontinuous with respect to the second decreasing segment, and the lateral distance between the ego vehicle and the adjacent lane indicia increases from an end of the first decreasing segment to a beginning of the second decreasing segment.

19. The method of claim 11, wherein characterizing the predicted lateral activity scenarios comprises characterizing each of the predicted lateral activity scenarios as a manual lane changing maneuver or an autonomous lane changing maneuver.

20. The method of claim 19, further comprising:
obtaining one or more manual lane changing metrics associated with the characterized manual lane changing maneuvers and one or more autonomous lane changing metrics associated with the characterized autonomous lane changing maneuvers; and wherein the adjusting the steering or actuation command is based on any difference between the manual lane changing metrics and the autonomous lane changing metrics.
